(19) United States
(12) Patent Application Publication
(10) Pub. No.: US 2026/0311229 A1
(43) Pub. Date: Oct. 8, 2026

(54) METHOD, MEDIUM, AND SYSTEM FOR VIRTUAL AGENTS TO HELP CUSTOMERS AND BUSINESSES

(71) Applicant: Voicemonk, Inc., Sunnyvale, CA (US)

(72) Inventors: Jagadeshwar Nomula, Sunnyvale, CA (US); Vinesh Gudla, Pleasanton, CA (US); Durga Prasad Velamuri, Fremont, CA (US); Vineel Yalamarthy, Rajahmundry (IN)

(73) Assignee: Voicemonk, Inc., Sunnyvale, CA (US)

(21) Appl. No.: 19/697,458

(22) Filed: Jun. 3, 2026

Related U.S. Application Data
(63) Continuation-in-part of application No. 19/432,921, filed on Dec. 24, 2025.
Application No. 19/432,921 is a continuation-in-part of application No. 19/255,827, filed on Jun. 30, 2025, now Pat. No. 12,572,967.
Application No. 19/255,827 is a continuation-in-part of application No. 18/474,130, filed on Sep. 25, 2023, now Pat. No. 12,548,048.
Application No. 18/474,130 is a continuation-in-part of application No. 19/234,241, filed on Jun. 10, 2025.
Application No. 19/234,241 is a continuation-in-part of application No. 16/245,188, filed on Jan. 10, 2019, now Pat. No. 12,639,593.
Application No. 19/255,827 is a continuation of application No. 18/676,471, filed on May 28, 2024, now Pat. No. 12,346,945.
Application No. 18/676,471 is a continuation of application No. 18/465,186, filed on Sep. 12, 2023, now Pat. No. 11,995,698.
Application No. 18/465,186 is a continuation of application No. 17/323,287, filed on May 18, 2021, now Pat. No. 12,039,583.
Application No. 17/323,287 is a continuation of application No. 15/356,512, filed on Nov. 18, 2016, now Pat. No. 11,068,954.
Application No. 18/474,130 is a continuation of application No. 17/484,779, filed on Sep. 24, 2021, now Pat. No. 11,769,175.
Application No. 17/484,779 is a continuation of application No. 15/441,239, filed on Feb. 24, 2017, now Pat. No. 11,144,964.
Application No. 15/441,239 is a continuation-in-part of application No. 15/391,837, filed on Dec. 27, 2016, now abandoned.
Application No. 15/391,837 is a continuation-in-part of application No. 15/356,512, filed on Nov. 18, 2016, now Pat. No. 11,068,954.
Application No. 19/234,241 is a continuation of application No. 16/006,850, filed on Jun. 13, 2018, now Pat. No. 12,450,631.
Application No. 16/006,850 is a continuation-in-part of application No. 13/089,772, filed on Apr. 19, 2011, now abandoned.
Application No. 13/089,772 is a continuation-in-part of application No. 15/245,208, filed on Aug. 24, 2016.
Application No. 15/245,208 is a continuation-in-part of application No. 13/208,338, filed on Aug. 12, 2011, now abandoned.
Application No. 13/208,338 is a continuation-in-part of application No. 15/391,837, filed on Dec. 27, 2016, now abandoned.
Application No. 15/391,837 is a continuation-in-part of application No. 15/356,512, filed on Nov. 18, 2016, now Pat. No. 11,068,954.
(60) Provisional application No. 61/400,663, filed on Aug. 2, 2010.
(60) Provisional application No. 62/257,722, filed on Nov. 20, 2015.
(60) Provisional application No. 62/257,722, filed on Nov. 20, 2015.
(60) Provisional application No. 62/275,043, filed on Jan. 5, 2016.
(60) Provisional application No. 62/275,043, filed on Jan. 5, 2016.
(60) Provisional application No. 62/318,762, filed on Apr. 5, 2016.
(60) Provisional application No. 62/318,762, filed on Apr. 5, 2016.
(60) Provisional application No. 62/543,400, filed on Aug. 10, 2017.
(60) Provisional application No. 62/616,428, filed on Jan. 12, 2018.

(51) Int. Cl. G06Q 30/0601; G06F 16/957

(52) U.S. Cl. CPC G06Q 30/0617; G06F 16/957; G06Q 30/0629

(57) ABSTRACT

A system and method are provided for dynamically selecting and invoking application programming interfaces (APIs), tools, functions, and workflows based on natural-language inputs and contextual user information. A virtual agent server maintains a semantic registry comprising identifiers, parameter definitions, and semantic annotations associated with a plurality of APIs and executable actions. A natural-language input is processed to determine a desired action and contextual information. Runtime semantic matching is performed between the natural-language input and semantic annotations to dynamically select one or more executable actions without use of a precompiled intent-specific routing definition. Parameter values are derived using dialog histories, contextual inference, runtime context information, and machine learning models. The system transmits a invocation request configured to cause a client application or external execution system to invoke the selected API, tool, function, or workflow, or alternatively executes the selected executable action on a server-side execution system using the derived parameter values.

### CROSS-REFERENCE TO RELATED APPLICATIONS

This application is a continuation-in-part of U.S. application Ser. No. 19/432,921, filed Dec. 24, 2025.

The U.S. application Ser. No. 19/432,921 is a continuation-in-part of application Ser. No. 19/255,827, filed Jun. 30, 2025, which is a continuation of application Ser. No. 18/676,471, filed May 28, 2024, which is a continuation of application Ser. No. 18/465,186, filed Sep. 12, 2023, which is a continuation of application Ser. No. 17/323,287 filed May 18, 2021, which is a continuation of application Ser. No. 15/356,512, filed Nov. 18, 2016, which claims benefit of provisional Application Nos. 62/257,722, 62/275,043, and 62/318,762, filed Nov. 20, 2015, Jan. 5, 2016, and Apr. 5, 2016, respectively.

Further, the U.S. application Ser. No. 19/432,921 is also a continuation-in-part of application Ser. No. 18/474,130, filed Sep. 25, 2023, which is a continuation of application Ser. No. 17/484,779, filed Sep. 24, 2021, which is a continuation of application Ser. No. 15/441,239, filed Feb. 24, 2017, which is a continuation-in-part of application Ser. No. 15/391,837, filed Dec. 27, 2016, which is a continuation-in-part of application Ser. No. 15/356,512, filed Nov. 18, 2016, which claims benefit of provisional Application Nos. 62/257,722, 62/275,043, and 62/318,762, filed Nov. 20, 2015, Jan. 5, 2016, and Apr. 5, 2016, respectively.

Further, the U.S. application Ser. No. 19/432,921 is also a continuation-in-part of U.S. application Ser. No. 19/234,241, filed Jun. 10, 2025, which is a continuation of U.S. application Ser. No. 16/006,850, filed Jun. 13, 2018, which claims the benefit of U.S. Provisional Patent Application No. 62/543,400, filed Aug. 10, 2017. The U.S. application Ser. No. 16/006,850 is a continuation-in-part of U.S. application Ser. Nos. 13/089,772, filed Apr. 19, 2011; Ser. No. 13/208,338, filed Aug. 12, 2011; Ser. No. 15/245,208, filed Aug. 24, 2016; Ser. No. 15/356,512, filed Nov. 18, 2016; and Ser. No. 15/391,837, filed Dec. 27, 2016. The U.S. application Ser. No. 15/245,208 claims the benefit of U.S. Provisional Patent Application No. 61/400,663, filed Aug. 2, 2010. The U.S. application Ser. No. 15/356,512 claims the benefit of U.S. Provisional Patent Application Nos. 62/257,722, filed Nov. 20, 2015; 62/275,043, filed Jan. 5, 2016; and 62/318,762, filed Apr. 5, 2016.

Further, the U.S. application Ser. No. 19/432,921 is also a continuation-in-part of U.S. application Ser. No. 16/245,188, filed Jan. 10, 2019, which claims priority from U.S. Provisional Patent Application No. 62/616,428, filed Jan. 12, 2018. All of the foregoing applications are incorporated by reference herein.

### DESCRIPTION OF RELATED ART

Customers browse through websites or software applications to look for products of interest to them. A customer can use a keyboard to enter keywords into the search box for which the website displays search results corresponding to the entered input. Further, the customer browses through the search results, filters them to select an item and either purchases it or adds it to the cart. In case the customer is interested in different products, they need to go back to the search box and enter a different search query. The same procedure needs to be repeated, which becomes tedious. Further, such websites and software applications are designed to work sequentially. If the customer wishes to add or search two or more items at the same time, it is impossible for them to do so since the customer needs to access different web pages to view different products.

Additionally, with an increase in the dependence of the web, many people now prefer completing a variety of work online instead of going out to physical stores. In physical stores, there are store attendants and employees who can help a customer while they are buying a product. However, when the same product is bought online, no such help is offered by conventional systems. When a customer wishes to place an order or clear doubts regarding a product, they make a call to an organization or a customer representative. Many times, a customer representative may not be available to talk to the customer. Other times, the customer is made to wait for long durations of time till they are connected to a customer representative. In such cases, the customer can feel frustrated due to the bad customer service. Conventional systems do not address this issue, which leads to an increase in time and effort spent by a customer.

Additionally, a customer cannot checkout multiple items in the same action and is forced to do actions in a sequence. Thus, the conventional systems failed to solve the above problems resulting in bad customer experience, which is not desirable. Further, with an increase in the number of consumers shopping online, it is of prime importance to improve customer experience, to increase revenue.

In addition, while customers experience the above discussed problems in their online engagement, brick and mortar stores have their own share of problems. In a brick and mortar store, products are stored in racks spread across the floor of the store. Often, it is difficult to locate the products in the store. Locating the products may require the customers or store assistants to browse through various racks in the store, which results in inefficient utilization of time and resources. In view of the foregoing discussion, there is a need to overcome the above problems and improve customer experience.

### SUMMARY OF THE INVENTION

The present disclosure relates generally to virtual agent systems and, more particularly, to systems and methods for dynamically selecting and invoking application programming interfaces (APIs), executable tools, functions, and workflows based on natural-language interactions and contextual user information.

In one implementation, a virtual agent system comprises a virtual agent client communicatively coupled to a virtual agent server configured to process natural-language inputs received from a user. The virtual agent server may maintain a semantic registry comprising identifiers, parameter definitions, semantic annotations, schema definitions, and execution information associated with a plurality of APIs, tools, functions, executable workflows, and software actions.

The virtual agent server may determine a desired action and contextual information associated with a natural-language input and may dynamically select one or more APIs, tools, functions, or executable workflows by performing runtime semantic matching between the natural-language input and semantic annotations associated with executable actions in the semantic registry. The runtime semantic matching may be performed without use of a precompiled intent-specific routing definition or hardcoded conversational flow.

In one implementation, the semantic registry may comprise one or more semantic retrieval structures including vector embeddings, semantic graphs, inverted indexes, transformer-based retrieval architectures, metadata structures, or hybrid semantic retrieval systems. The virtual agent system may further perform multi-stage retrieval operations including candidate retrieval and contextual ranking using one or more machine learning models or learn-to-rank algorithms.

The virtual agent server may derive parameter values associated with a selected executable action using contextual information determined from current and previous dialog sessions, named entity recognition, inference rules, runtime context information, application state information, user preferences, historical interaction data, or machine learning models.

In one aspect, the virtual agent server may generate or transmit a structured invocation request configured to cause a client application, orchestration engine, browser application, external execution system, remote server, or software agent to invoke the selected API, function, tool, or executable workflow on behalf of the user. In another implementation, the virtual agent server may directly execute the selected executable action using server-side execution systems.

The structured invocation request may comprise one or more of a function-calling payload, tool invocation payload, API call payload, schema-based request, executable manifest, orchestration instruction, or natural-language execution request. In certain implementations, APIs and executable tools may be discovered automatically by crawling software applications, websites, APIs, or schema definitions including OpenAPI specifications, Swagger specifications, JSON schemas, or tool-calling definitions.

In some implementations, the virtual agent system may exchange optimization preferences, execution constraints, or workflow parameters with external systems and may determine common optimization options for execution of the selected executable action. The optimization options may include latency preferences, cost preferences, personalization constraints, delivery preferences, execution quality preferences, or security requirements.

In some implementations, portions of the semantic registry, execution logic, or parameter derivation logic may be synchronized to a client device for local execution when communication with the virtual agent server becomes unavailable or degraded.

Accordingly, the disclosed systems and methods provide improved context-aware execution of APIs, tools, functions, and workflows across distributed computing environments while enabling dynamic runtime semantic action selection, cross-system orchestration, and flexible execution architectures.

Other objects, features, and advantages of the present disclosure will become apparent from the following detailed description. It should be understood, however, that the detailed description and specific examples, while indicating preferred implementations of the present disclosure, are given by way of illustration only, and that various modifications may be made without departing from the scope of the present disclosure as defined by the appended claims.

### BRIEF DESCRIPTION OF DRAWINGS

Implementations are illustrated by way of example and not limitation in the Figures of the accompanying drawings, in which like references indicate similar elements and in which:

FIG. 1 is an exemplary block diagram illustrating a virtual agent 100 comprising a virtual agent server 104, in accordance with an implementation;

FIG. 2 is an exemplary block diagram 200 illustrating interactions between a virtual agent client 202 and an exemplary virtual agent server 104, in accordance with an implementation;

FIG. 3 illustrates schemes and components which may be used to update dialogue states for a dialogue service, in accordance with an implementation;

FIG. 4 illustrates interactions between a virtual agent client 202 and a browser in the process of instantiating actions for a user, in accordance with an implementation;

FIG. 5 illustrates a flowchart illustrating the enabling of a virtual agent 100 coupled to a virtual agent server 104 to handle customer service calls, in accordance with an implementation;

FIG. 6 illustrates a flowchart 600 illustrating a virtual agent 100 helping a user in finding a physical route, in accordance with an implementation; and

FIG. 7 illustrates working of the virtual agent client 202 and virtual agent server 104 integrated with an e-commerce application 700, in accordance with an embodiment.

FIG. 8 depicts an exemplary architecture of a virtual agent server 800, in accordance with an embodiment;

FIG. 9 depicts a system 900 including the virtual agent server 800 for assisting in conversational marketing, in accordance with an embodiment;

FIG. 10 depicts a flowchart of an exemplary method 1000 for interactive advertisement with a user, in accordance with an embodiment;

FIG. 11 depicts a flowchart of an exemplary method 1100 for communicating advertisements to a user, in accordance with an embodiment; and

FIG. 12 depicts a flow diagram of an exemplary method 1200 for communicating advertisements to a user through actionable marketing, in accordance with an embodiment.

FIG. 13 illustrates an exemplary architecture of a system 1300 for generating search tokens for a user, in accordance with an embodiment;

FIG. 14 illustrates an exemplary block diagram 1400 of a server 1304, in accordance with an embodiment;

FIG. 15 illustrates an exemplary block diagram 1500 of a token generation module 1406 for the system 1300, in accordance with an embodiment;

FIG. 16 illustrates an exemplary block diagram 1600 for a behavior-to-search model for the system 1300, in accordance with an embodiment;

FIG. 17 illustrates an exemplary block diagram 1700 for a wide and deep neural network for the system 1300, in accordance with an embodiment;

FIG. 18 illustrates an exemplary flow diagram 1800 depicting a method for using aggregated user behavior using the system 1300, to enrich Deep Reinforcement Learning algorithms for the system 1300, in accordance with an embodiment; and

FIG. 19 illustrates an exemplary flow diagram 1900 depicting a method for generating a hyper-personalized marketing message for the system 1300, in accordance with an embodiment.

FIG. 20 is an exemplary block diagram illustrating software modules of a system 2000 for recommending content and actions based on user behaviour, in accordance with an embodiment.

FIG. 21 is a flowchart 2100 illustrating the steps involved in building a generalized model 2108 a, in accordance with an embodiment.

FIG. 22 is a flowchart 2200 illustrating the steps involved in building a personalized model 2208 a of the behaviour analyzer 2002, in accordance with an embodiment.

FIG. 23A is a flowchart 2300 of an exemplary method for recommending content and predicting user actions, by the behaviour analyzer 2002, in accordance with an embodiment.

FIG. 23B, FIG. 23C, FIG. 23D, FIG. 23E, and FIG. 23F illustrate user interfaces enabled by the behaviour analyzer 2002, in accordance with an embodiment.

FIG. 24 is a flowchart of an exemplary method 2400 enabled by a virtual agent facilitated by the behaviour analyzer 2002, in accordance with an embodiment.

FIG. 25 is a block diagram illustrating hardware elements of the system 2000 of FIG. 20, in accordance with an embodiment.

### DETAILED DESCRIPTION

In the following detailed description of exemplary implementations of the disclosure in this section, specific exemplary implementations in which the disclosure may be practiced are described in sufficient detail to enable those skilled in the art to practice the disclosed implementations. However, it is to be understood that the specific details presented need not be utilized to practice implementations of the present disclosure. The following detailed description is, therefore, not to be taken in a limiting sense, and the scope of the present disclosure is defined by the appended claims and equivalents thereof

A customer using websites and software applications can have better customer experience using virtual agents 100. A virtual agent 100 can speak with a customer in a natural voice. The virtual agent 100 can start with a pleasant greeting in a personalized voice and can ask the customer what they would like to do. The virtual agent 100 can use input from the customer that is in the form of voice, speech, facial expressions, head movement and eye movement inputs. The virtual agent 100 processes the input from the customer, considers different scenarios and presents suggestions to help the customers. Further, the virtual agent 100 presents the customer with one or more options for execution. The customer's chosen option can be executed by the virtual agent 100. Further, the virtual agent 100 can converse with the customer using natural language speech as a customer service representative. Additionally, the virtual agent 100 can answer questions asked by the customer regarding products or services available, and location of products within a commercial establishment.

The virtual agent 100 may be used to execute one or more actions desired by the user based on received user input. The virtual agent 100 may store one or more correlations between actions available in a software application. Further, the virtual agent 100 may associate one or more actions with tags describing the actions. The virtual agent 100 may process user inputs and use the tags associated with actions to identify the action desired by the user. Further, the virtual agent 100 may execute one or more actions based on the user's desired action and the correlation between actions in a software application. An example of actions carried out in a website may be: search, sort, select, compare and submit, among others.

As an example, a virtual agent 100 may identify one or more actions on a software application or a website and associate each action with a descriptive tag. When a user says “show me the latest mobile phones available today.”, the virtual agent 100 may understand that the user's desired action is a “search” action. Hence, the virtual agent 100 may execute an action with a tag related to “search”, and associate a context of “mobile phones” with the “search” action.

### Virtual Agent System

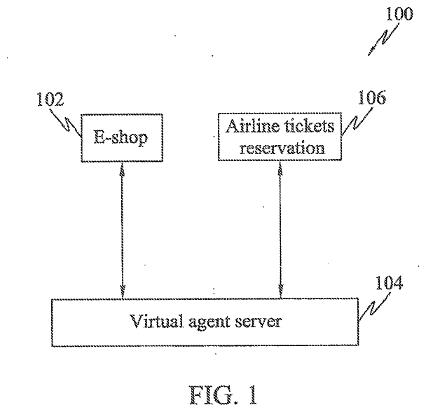

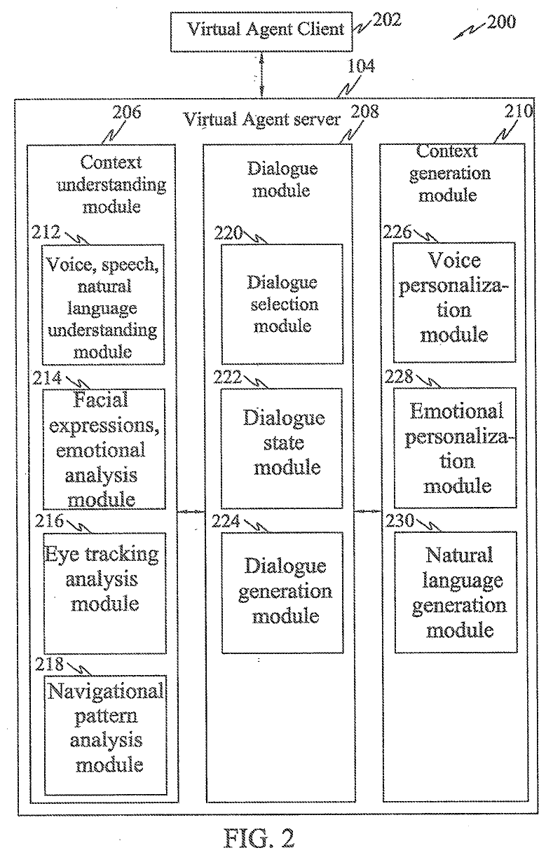

FIG. 1 depicts a diagram illustrating an exemplary architecture of a client-server based virtual agent system 100, in accordance with an implementation. A backend virtual agent server 104 may be coupled to a virtual agent client 202 (shown in FIG. 2) to interact with users. The virtual agent server 104 may interact with various websites or software applications, for example, an e-shop 102. The virtual agent server 104 may complete one or more tasks for the user such as booking appointments, buying tickets or placing orders, among other tasks done through a website or a software application. One example for a software application may be an Airline tickets reservation 106 where the user may instruct the virtual agent 100 to check flight rates or book tickets, among other tasks. Further examples may include buying movie tickets, tickets to theatre shows and concerts, among others.

In an embodiment, the virtual agent is a third-party application configured to interface and function with software applications, such as e-commerce applications, among others. Hence, a small or medium sized e-commerce player can enable his users to use the functionality enabled by the virtual agent by integrating the virtual agent with the eCommerce application, without the need to develop the functionality of the virtual agent specifically for his/her eCommerce application.

In an implementation, the virtual agent server 104 may receive one or more voice, speech, facial, head motion and eye tracking inputs, among others, from a virtual agent client 202 and may understand the inputs using a context understanding module 206. Further, the virtual agent server 104 may prepare a response with speech, voice and emotions using the context generation module 210. Further, the virtual agent client 202 may share the response with the user.

In an implementation, FIG. 2 depicts a diagram illustrating interactions between a virtual agent client 202 and an exemplary virtual agent server 104, exemplary components of the virtual agent server 104, and interactions between the components of the virtual agent server 104, in accordance with one or more implementations of the present disclosure.

In an implementation, the virtual agent 100 may comprise a virtual agent client 202 which may be coupled to a backend virtual agent server 104 wherein the virtual agent client 202 and the virtual agent server 104 may work together to complete a task of the user.

In an implementation, the virtual agent client 202 may be provided in a website or a software application to interact with users. The virtual agent client 202 present in the browser of the website or the mobile application may be implemented by software. Further, in an implementation, the virtual agent client 202 may be implemented in one of a native, JavaScript or html code, among other coding languages that exist or may exist in the future.

In an implementation, the virtual agent client 202 may start to engage the user in case they open a software application or website. The virtual agent client 202 may enable the input given by the user to be used for determining the context of the user. Further, it may enable execution of one or more actions in the software application or website as requested by the user. These actions may include one or more of a search, viewing an item, a checkout action and filtering results, among others in a retailing context.

In an implementation, the virtual agent 100 may comprise a virtual agent server 104 which may further comprise a context understanding module 206, a dialogue module 208 and a context generation module 210. In an implementation, the virtual agent server 104 may process inputs from the user using context understanding module 206. Such inputs may include one or more of voice, speech, facial, head motion, application navigation, or eye tracking inputs, among others. The dialogue module 208 may keep track of the spoken dialogue conversation between the virtual agent 100 and the user; and may provide a dialogue service to enable spoken dialogue interaction between the user and the virtual agent 100. Further, the virtual agent server 104 may use the context generation module 210 to determine appropriate speech, voice and emotions for the communication to be made by the virtual agent client 202 with the user.

The context understanding module 206 may further include a voice, speech and natural language understanding module 212, a facial expressions and emotional analysis module 214, an eye-tracking analysis module 216 and a navigational patterns analysis module 218.

In an implementation, the voice, speech and natural language understanding module 214 may process the content of the user's speech to understand the inputs and requirements of the user. The voice, speech and natural language understanding module 214 may understand the speech context from the user and determine the user's needs. The context may be derived from explicit inputs given by the user and may correspond to an action desired by the user. Further, the determined context may be incorporated while executing one or more actions on behalf of the user.

The speech context may comprise textual words used by the user in the current session and/or previous “m” sessions. Further, “m” may be manually configured or tuned for a software application using one or more algorithms such as Machine Learning, among others.

In an implementation, the voice, speech and natural language understanding module 214 may assign weights to tokens (individual words) detected in the speech context using Term Frequency Inverted Document Frequency (tfidf) and the recency of the communication session. The voice, speech and natural language understanding module 214 may also assign appropriate weights to words detected in previous “m” sessions and may include them in the current communication session. The speech context may also include one or more explicit inputs or inferences from previous natural conversation sessions which are decayed using recency of occurrence. Further, the output displayed by the virtual agent 100 may depend on the context derived from these explicit inputs using current and previous communication sessions.

In an implementation, the voice, speech and natural language understanding module 214 may also determine a voice context of the user's communication session. The voice context may include one or more of the intensity of speech and frequency of the speech, among others.

In an implementation, the voice, speech and natural language understanding module 214 may use one or more slot filling algorithms to recognize text and interpret the conversation. Further, in case the virtual agent server 104 determines that more slots need to be filled, the dialogue state module 222 of the dialogue module 208 may use the voice, speech and natural language understanding module 214 of the context generation module 210 to ask one or more clarifying questions to the user. This may be done to increase engagement with the user and collect additional information from the user to fill the required slots.

In an implementation, the virtual agent 100 may estimate an age of the speaker from vocal cues. Age-related changes in anatomy and physiology may affect a person's vocal folds and vocal tract; hence, a person's age may be estimated using one or more vocal cues from the audio input comprising the speaker's voice. One or more vocal cues or measures such as jitter, shimmer, and Mel-frequency cepstral coefficients may be used to correlate the user's voice with age.

In an implementation, the context understanding module 206 may use manual rules followed by natural language analysis techniques to understand the verbal feedback of the user.

In an implementation, the facial expressions and emotional analysis module 214 within the context understanding module 206 may process the inputs received from the virtual agent client 202 to determine an emotional state of the user based on the reactions of the user. The facial expressions and emotional analysis module 214 may analyse one or more facial and head motion frames (e.g., sideways, upwards and downwards) of the user and process them by using one or more techniques such as predictive, machine learning or deep learning techniques, among others, to understand emotional reactions of the user.

In an implementation, the eye tracking analysis module 216 within the context understanding module 206 may include an eye tracking system that may receive one or more video recordings of the user from the virtual agent client 202 and process them to track the movement of the user's eyes across the device screen on which the website or software application is running. Further, the eye tracking analysis module 216 may process the tracked eye movements to determine one or more top ‘y’ positions viewed by the user on the device screen. Subsequently, the virtual agent 100 may decide on one or more courses of action based on these top ‘y’ positions.

In an implementation, the navigational patterns analysis module 218 within the context understanding module 206 may include a navigation pattern tracking system that may receive inputs of the user's navigation across the website/software application from the virtual agent client 202 and process them to track the user's navigation. Further, the navigational patterns analysis module 218 may process the tracked website navigation to determine one or more items of interest on the website that may have interested the user. Subsequently, the virtual agent 100 may decide on a course of action based on these items.

In an implementation, the dialogue module 208 may help to coordinate one or more actions between the context understanding module 206 and the context generation module 210. The dialogue module 208 may keep track of the spoken dialogue conversation between the virtual agent 100 and the user. Further, the dialogue module 208 may provide a dialogue service that allows spoken dialogue interaction between the user and the virtual agent 100.

In an implementation, the dialogue module 208 may process inputs received from the virtual agent client 202 to understand the context of the communication session with the user by using the context understanding module 206. Further, the dialogue module 208 may personalize user experience using the context generation module 210 after computing top ‘n’ weighted options of possible actions.

In an implementation, the dialogue module 208 may generate one or more clarification questions to comprehend the user's desired action with the help of the context understanding module 206. In case the dialogue module 208 comprehends the user's intention, it may map the intention to a user action in the application and send it back to the virtual agent client 202 along with a verbal confirmation. The dialogue module 208 may use one or more predictive or machine learning classification and/or ranking algorithms to process the context computed from the context understanding module 206. Further, it may map the context to a list of weighted actions to be executed by the virtual agent 100 on the website or software application.

In an implementation, an offline process may construct the mapping between actions or states and user commands. The association between the possible actions and the user commands may be determined by crawling the website or software application and determining associations between the possible actions and the user commands. This may be done by using one or more techniques such as pattern matching and/or entity name recognition techniques. This type of mapping may also be built by a manual configuration of rules.

In an implementation, the mapping between actions, intents, application programming interfaces (APIs), functions, tools, and executable operations may be determined dynamically at runtime without requiring a precompiled or hardcoded intent-specific routing definition. The dialogue module 208 and/or the context understanding module 206 may perform semantic matching between a natural-language input and one or more semantic annotations associated with APIs, executable functions, tools, or actions stored in a semantic registry. The semantic annotations may include one or more of keywords, synonyms, contextual descriptors, embeddings, semantic vectors, metadata tags, usage patterns, action descriptions, schema descriptions, parameter descriptions, and historical execution information.

In an implementation, the semantic registry may maintain, for each API, tool, function, executable workflow, or software action, one or more identifiers, parameter definitions, parameter descriptions, semantic annotations, invocation templates, schema definitions, execution constraints, permission requirements, authentication requirements, and execution endpoints. The semantic registry may be stored in one or more databases, graph structures, vector databases, embedding indexes, hashmaps, inverted indexes, semantic retrieval systems, or distributed storage systems.

In an implementation, the virtual agent 100 may dynamically select an API, tool, function, executable workflow, or software action at runtime without use of a precompiled intent-specific routing definition, hardcoded intent map, or manually predetermined conversational pathway. Instead, the selection may be performed using runtime semantic matching between a user's natural-language input and semantic annotations associated with available APIs, tools, functions, executable workflows, or software actions.

In an implementation, semantic annotations associated with parameters may comprise one or more parameter names, synonyms, contextual descriptors, semantic labels, embeddings, vector representations, metadata tags, usage examples, historical associations, ontology relationships, or natural-language descriptions corresponding to the parameters of an API, tool, function, or executable workflow.

In an implementation, a mapping in the dialogue module 208 may be executed as follows: the dialogue module 208 may determine the user's intention and may query the inventory of the website or software application to determine if it has any actions available for the user which may satisfying the user. The parameters required to complete the query may be manually configured or discovered by crawling the website or software application.

In an implementation, runtime semantic matching may comprise dynamically comparing one or more portions of a natural-language input against semantic annotations, vector embeddings, metadata descriptors, contextual representations, or parameter descriptions associated with a plurality of APIs, tools, functions, or executable workflows to identify one or more candidate executable actions.

In an implementation, the virtual agent server 104 may select one or more APIs, tools, functions, or executable actions by performing semantic similarity analysis between the user's natural-language input and semantic annotations associated with available APIs or tools. The semantic similarity analysis may use one or more techniques including vector embeddings, transformer-based attention models, semantic ranking models, contextual matching models, neural retrieval systems, inverted indexes, keyword matching systems, graph traversal systems, or hybrid retrieval architectures.

In an implementation, the semantic retrieval architecture may include one or more attention-based semantic retrieval structures implemented using transformer neural networks, attention layers, contextual embedding systems, sequence models, neural retrieval models, or semantic ranking architectures.

In an implementation, the second-pass ranking stage may comprise a learn-to-rank process configured to rank candidate APIs, tools, functions, workflows, or executable actions according to contextual relevance, semantic similarity, historical usage patterns, user preferences, or execution likelihood.

In an implementation, the semantic retrieval process may comprise a first-pass candidate retrieval stage followed by a second-pass ranking stage. The first-pass candidate retrieval stage may identify one or more candidate APIs, functions, tools, or executable actions using keyword matching, vector similarity, embedding retrieval, graph traversal, or inverted index retrieval. The second-pass ranking stage may rank the candidate APIs, functions, tools, or executable actions using one or more machine learning models, learn-to-rank algorithms, Gradient Boosted Decision Trees, transformer ranking models, neural ranking models, or contextual scoring techniques.

An example of a mapped action named “search action” may be described as follows:

| | |
|---|---|
| Event: | Search action |
| Input Box-Id: | “search-box” |
| Query: | {query output from context output module} |
| Button-Id: | “search-submit” |
| Action: | “click” |
| Voice output: | “I am searching {query output |
| | from context input module} for you. |
| | Please let me know if you want |
| | to change your search criteria.” |

In an implementation, the virtual agent 100 may generate a structured invocation request configured to cause a client application, browser application, orchestration engine, external execution system, remote server, software agent, or third-party system to invoke a selected API, function, or tool. The structured invocation request may comprise one or more parameter values derived from the user's natural-language input and contextual information determined from one or more previous dialog sessions.

In an implementation, the structured invocation request may comprise one or more of an API call payload, function-calling payload, tool invocation payload, schema-based request, JavaScript Object Notation (JSON) payload, remote procedure call request, executable command structure, orchestration instruction, workflow execution request, or natural-language dialog instruction. In some embodiments, the invocation request comprises a JSON-formatted payload identifying the application programming interface, parameter values, and execution instructions.

In an implementation, the structured invocation request generated by the virtual agent server 104 may be transmitted to a client-side execution environment for execution. The client-side execution environment may comprise a browser application, mobile application, desktop application, software development kit (SDK), plugin, extension, embedded software module, orchestration framework, or external application configured to execute one or more APIs, functions, or tools on behalf of the user.

In another implementation, the virtual agent server 104 may directly execute the selected API, function, tool, or executable action using one or more server-side execution systems. The server-side execution systems may include cloud computing systems, orchestration servers, workflow engines, application servers, distributed processing systems, or remote execution frameworks.

In an implementation, the structured invocation request generated by the virtual agent server 104 may be configured to cause a client application, browser application, orchestration engine, external execution system, or remote software agent to invoke a selected API, function, tool, or executable workflow using parameter values derived from the user's natural-language input.

In an implementation, an external execution system may comprise one or more remote servers, cloud services, orchestration frameworks, workflow engines, browser-based execution environments, software agents, client-side execution modules, mobile applications, third-party software systems, or distributed computing systems capable of invoking or executing one or more APIs, tools, functions, or executable workflows.

In an implementation, a function-calling payload or tool invocation payload may comprise a structured schema identifying a callable function, executable tool, API endpoint, parameter set, parameter values, authentication information, execution constraints, or execution instructions. The payload may be formatted according to one or more structured formats including JavaScript Object Notation (JSON), schema-based definitions, remote procedure call formats, executable manifests, or tool-calling specifications.

In an implementation, the dialogue module 208 may share one or more of the mappings with the context generation module 210. Further, the context generation module 210 may work with the virtual agent client 202 to communicate the voice output in a personalized accent and instantiate actions for the user on the website or software application without the user's involvement.

In an implementation, as an example, the virtual agent 100 may assist the user while they are shopping online by conversing with the user and providing one or more suggestions to them. In this case, the user may have shared a verbal feedback such as “This dress is too dark and expensive”. In this case, the dialogue module 208 may first identify that the user is giving feedback based on one or more inputs corresponding to what the user was doing when they gave the feedback and what their previous actions were. These inputs may be determined by using a Hidden Markov model trained offline with feedback from context understanding module 206. Further, upon determining that the user's speech is a feedback dialogue, the dialogue module 208 may label each of the user's words to one or more item characteristics using a Recurrent Neural Network which may be trained offline.

In an implementation, as an example, the sentence “This dress is too dark and expensive” may be processed and understood by the virtual agent 100 as follows: a ‘dress’ may refer to a type of item, ‘dark’ may refer to the colour of the item and ‘expensive’ may refer to the price of the item. Further, upon determining one or more labels in the dialogue, the virtual agent 100 may determine if it has sufficient information needed to process the natural dialogue of the user. This may be done by evaluating it against a feedback natural dialogue slot configuration in the application. Further, in case the virtual agent 100 determines from the feedback from the dialogue module 208 that there is insufficient information to work with, the virtual agent 100 may ask one or more clarification questions such as “is the design of this dress okay?”. This may prompt the user to share more information that may then be processed to determine the needs of the user.

In an implementation, the dialogue module 208 may answer one or more questions raised by the user. This may be done by converting vocal questions into text annotating the tokens in the text with part of speech tags and matching the questions into preformatted question formats. Further, the dialogue module 208 may ask one or more clarification questions to the user, in case it determines that all the slots are not filled in the dialogue session for it to act on the user's behalf.

In an implementation, the dialogue module 208 may derive parameter values for a selected API, tool, function, or executable action by processing one or more previous dialogs associated with the user. Tokens from previous dialogs may be annotated using named entity recognition techniques, contextual labeling systems, machine learning classifiers, transformer models, sequence labeling models, or rule-based systems. One or more inference rules may then be executed on the annotated dialogs to derive missing parameter values, contextual values, inferred preferences, authorization attributes, or execution constraints.

The dialogue service of the virtual agent 100 may be selected using the dialogue selection module 220. Different types of dialogues may be selected based on one or more of context, user personality and user requirements, among others.

In an implementation, the dialogue state module 222 in the dialogue module 208 may use the voice, speech and natural language understanding module 214 to ask one or more clarifying questions to the user to fill any required slots. Further, the dialogue module 208 may hold information corresponding to one or more possible actions for the user using the dialogue state module 222. The possible dialogue states may also be configured manually with weights by a programmer.

In an implementation, the virtual agent 100 may crawl a website or software application to identify one or more outward links, web-forms, and information that may be present in the website or software application. The virtual agent 100 may use pattern matching, hand written rules and one or more machine learning algorithms such as Hidden Markov Model (HMM) and Conditional Random Fields (CRF), among others, for identification of the links and web-forms. The virtual agent 100 may then add an action for each link and/or web form in the dialogue state module 222. These links and web forms may be tagged with one or more keywords and synonyms with the help of manual tagging, offline call and log analysis. This may be done to increase the match percentage related to voice conversations from the user.

In an implementation, the virtual agent 100 may automatically crawl websites, software applications, APIs, executable tools, function schemas, or software interfaces to discover one or more executable actions, parameters, functions, workflows, endpoints, or invocation structures. The discovered information may be transformed into semantic annotations and stored in the semantic registry for subsequent runtime semantic matching and execution.

In an implementation, APIs or executable tools may expose schema definitions describing one or more callable functions and associated parameters. The virtual agent 100 may parse the schema definitions to determine semantic meanings associated with parameters, actions, or executable functions. The schema definitions may include one or more of OpenAPI specifications, Swagger specifications, JSON schemas, function calling schemas, tool definitions, metadata descriptors, executable manifests, or orchestration specifications.

In an implementation, as an example, a user may have said “Reserve Holiday Inn hotel”, and the virtual agent 100 did not understand the speech. The user may discontinue using the virtual agent 100 and may type “Holiday Inn” into the search box manually to make reservations in the hotel. In such a case, the virtual agent 100 may add a rule for that search action stating that in case the text in the input for the context understanding module 206 has a word similar to “Reserve *” then the user may intend to reserve a hotel and hence the virtual agent 100 may need to send the appropriate action to the virtual agent client 202.

In an implementation, the dialogue module 208 may use previous logs of user interaction with the virtual agent 100 as training data. This training data may be used for building and improving one or more algorithms such as machine learning models and/or predictive algorithms in the context understanding module 206 and the dialogue module 208.

In an implementation, the virtual agent 100 may use interaction logs, execution histories, failed invocation attempts, clarification dialogs, and user corrections as training data for improving runtime API selection and parameter derivation. One or more machine learning models may learn associations between user utterances, semantic contexts, executable actions, and parameter values to improve future API or tool selection accuracy.

In an implementation, a Recurrent Neural Network may learn from the log data in case the user says “Reserve Holiday Inn hotel” and was not happy with virtual agent 100's response and may issue a Reservation action for “Holiday Inn”. In this case, the virtual agent 100 may tag ‘Reserve’ as an action and ‘Holiday Inn hotel’ as an input to the reservation action.

In an implementation, the dialog service of the virtual agent 100 may be generated using the dialogue generation module 224. Different types of dialogues may be generated based one or more of context, user personality and user requirements, among others.

In an implementation, the context generation module 210 may further include a voice personalization module 226, an emotional personalization module 228 and a natural language generation module 230.

In an implementation, the context generation module 210 may present the user with top ‘n’ options to choose in a verbal conversation. The context generation module 210 may determine the possible outputs or actions that the user may be interested in, given the current dialogue state of engagement between the user and the virtual agent 100.

In an implementation, the context generation module 210 may generate responses indicating execution of APIs, tools, functions, or executable workflows on behalf of the user. The generated response may include confirmations, execution summaries, optimization suggestions, alternative execution paths, or requests for additional parameters needed for execution.

In an implementation, the voice personalization module 226 may personalize the virtual agent 100's voice based one or more of the user's details. The virtual agent 100 may determine one or more user information including age group, gender, information processing speed and style of the user with the help of one or more predictive and machine learning methods. In some cases, the virtual agent 100 may have stored one or more of the user information mentioned above, in a database. Alternatively, one or more of the user information mentioned above may be collected from previous sessions.

After determining one or more user details such as age, gender, location, accent and other user information, the virtual agent 100 may decide to use different customizations and combinations of gender, voice, accent and language to communicate with the user using a plurality of modules to optimize engagement with the user. Different voice outputs may be trained offline for different personality types.

In an implementation, a generic parameterized HMM model for converting text to speech may be customized according to different personality types by asking different personality type persons to record the same text. This model may then be used in a speech synthesis model to generate appropriate sound waves with the right prosodic features for the text customized by the parameters determined during training. To determine the right voice for a user session, the virtual agent 100 may run one or more Collaborative Filtering algorithm and/or predictive algorithms with user's age, under, location, time of the day. Further, the virtual agent 100 may score each voice to choose one which may increase the engagement with the current user.

In an implementation, the emotional personalization module 228 may determine one or more emotions to be used in the dialogue service for the client. The virtual agent 100 may start its speech with a pleasant greeting in a personalized voice. Further, it, may ask the user one or more questions such as what they would like to do, and subsequently present the user with one or more top ‘x’ options in case the user opens a website or app for a retail store such as AMAZON.

In an implementation, in case the virtual agent server 104 has determined that more information may be required from the user, the natural language generation module 230 in the context generation module 210 may be used to provide questions to the user. This may be done to increase engagement with the user to collect more information to fill the required slots. Further, the natural language generation module 230 may generate appropriate responses during the conversation with the user.

In an implementation, the virtual agent server 104 may exchange optimization options, execution preferences, or workflow constraints with a second virtual agent server, orchestration system, client application, or external execution system. The exchanged optimization options may include cost optimization preferences, timing preferences, delivery preferences, latency preferences, personalization preferences, security requirements, or execution quality constraints. The virtual agent server 104 may identify one or more common optimization options between the systems and may execute or cause execution of the selected API, tool, or workflow according to the identified common optimization options.

In an implementation, taking an example of a merchant website, the context understanding module 206 may receive image input or speech of the user and may process them to understand the user's verbal, navigational and emotional inputs. Further, the context understanding module 206 may analyse the user's inputs to determine one or more items that the user is interested in. Subsequently, the context understanding module 206 may process the user's inputs to determine one or more parameters such as colour, fit, price and style of items that the user may be interested in. Further, the context understanding module 206 may analyse the inputs of the user, access additional information from the dialogue module 208 and send an output to the dialogue state module. The parameters considered by the context understanding module 206 may be manually configured at appropriate item levels or category levels of the item.

In an implementation, the virtual agent client 202 may communicate one or more inputs of the user to the context understanding module 206 to determine context and reasons for user unhappiness. The context understanding module 206 may process these inputs to determine the extent of user unhappiness and determine further suggestions or possible actions. Further, the virtual agent 100 may use the suggestions to generate various item suggestions for cross selling them to the user.

In an implementation, portions of the semantic registry, execution logic, parameter derivation logic, or executable code may be pushed from the virtual agent server 104 to the virtual agent client 202 for local execution. When communication with the virtual agent server 104 becomes unavailable or degraded, the virtual agent client 202 may locally execute one or more APIs, tools, workflows, parameter derivation operations, or executable actions using previously synchronized executable code, semantic mappings, vector representations, hashmaps, or cached contextual information.

In an implementation, the virtual agent server 104 may execute a selected API, function, tool, or workflow directly, or may cause execution of the selected API, function, tool, or workflow by transmitting a structured invocation request to another computing system configured to perform the execution.

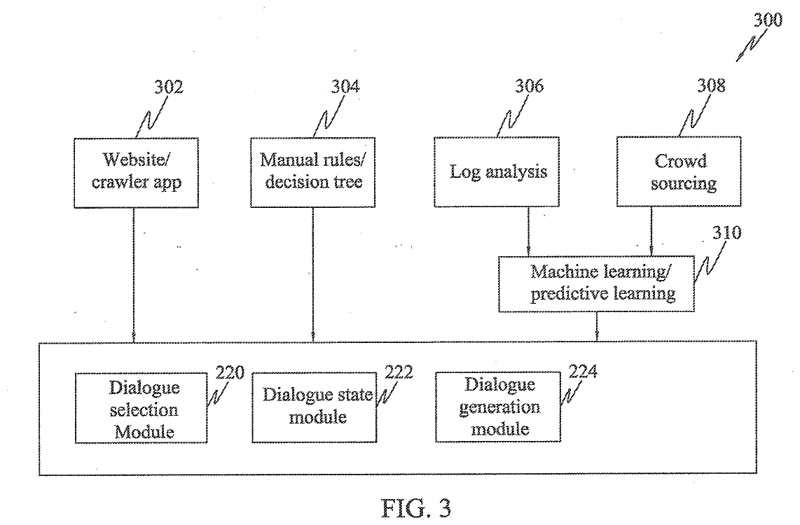

FIG. 3 depicts a diagram illustrating schemes and components which may be used to update dialogue states for a dialogue service (namely, a service provided to enable spoken dialogue interaction between a user and the virtual agent 100), according to one or more implementations of the present disclosure. In an implementation, one or more of the possible dialogue states may be configured manually with weights by a programmer as per step 304. In another implementation, the website or app may be crawled as shown at step 302 to determine one or more correlations between one or more of different actions on the webpage, outward links, web-forms, and information, among others, by using one or more methods such as pattern matching, hand written rules and machine learning algorithms such as Hidden Markov Model (HMM) and Conditional Random Fields (CRF), among others. Further, an action for one or more of the link(s) and/or web form(s) in the Dialogue State module 222 may be added. The links and web forms may be enriched with one or more keywords and synonyms though manual tagging, offline call and log analysis, among others, to increase match percentage to voice conversations from the user.

In an implementation, as an example, parsing through the logs the virtual agent may have determined that a person has said “Reserve Holiday Inn hotel”, but the virtual agent 100 did not understand the speech. The user gives up on the Virtual Agent 100 and types “Holiday Inn” manually into the search box and reserves the hotel. At step 304, we may add a rule for the search action saying that if the text in input to the NLU module 212 has got a pattern for “Reserve *” then the user intends to reserve a hotel and the Virtual Agent 100 should send appropriate action to the Virtual agent client 202 interacting with the user.

The correlations between the actions may be of different types such as sequential, hierarchical or lateral correlations. As an example, if a user asks “show me toy cars which are red”, then the virtual agent 100 will determine that two actions are desired, searching for a toy car and filtering only red ones. Here, search action needs to be executed before filter action, hence this could be an example of a hierarchical correlation. If a user asks “help me book tickets”, then the virtual agent 100 may sequentially execute actions to help the user book the start point, destination, time of flight, cost, and so on. In case of a lateral correlation, the user may use an e-commerce website and ask “Add one pound of bread to my cart and show me different jams”, in which case the actions for adding to the cart and showing jam need to be executed laterally. Thus, at least two of the actions on a website which are executed by the virtual agent 100 may be correlated sequentially, hierarchically, or laterally.

In an implementation, a virtual agent 100 may work like a virtual salesman by helping a user when they use a website or software application. The virtual agent 100 may process one or more types of implicit inputs corresponding to the user such as the user's facial expressions, voice, speech, visual and application navigation pattern clues to determine whether the user is unhappy with the browsed item. Further, these implicit inputs may be used to determine the sentiment of the user. The unhappiness of the user may be determined based on one or more of the user's facial expressions, speech, visual and application navigation clues. The virtual agent 100 may determine such details with the help of one or more predictive or machine learning code included in the code of the website or software application; or it may be co-located on the browser or on the virtual agent server 104. Further, the predictive or machine learning codes may process information related to the user including a duration for which the user has looked at the item, navigation patterns on the page, speech cues and vision context, among others, to generate a score for the user's unhappiness called an unhappiness score.

In an implementation, the unhappiness score may be generated by using a manually tuned formula based on the above features. Alternatively, an algorithm such as Linear Regression may be trained on previous interactions and/or crowd sourced data. This algorithm may also be used to generate the unhappiness score.

In an implementation, evaluation code for the unhappiness score may alternatively be stored in a remote server, in which case the virtual agent 100 on the website or software application may pass the context of the user to the remote server. Further, this remote server may send back an unhappiness score to the application. In some cases, the virtual agent 100 may determine that the user may be unhappy with the output results displayed by the virtual agent 100. In this case, the virtual agent 100 may suggest or carry out one or more actions to reduce the unhappiness of the user. These suggestions or actions may be based on some parameters in the software application and any provisions that address such parameters. As an example, in case the user is unhappy with a displayed item, the virtual agent 100 may suggest different sizes, prices or brands related to that item on the website. In an implementation, the virtual agent 100 may suggest alternatives for one or more factors such as price, shape, size, color, brand or manufacturer, among other suggestions which may be used during cross selling a product or a service to a user in a retailing context.

In an implementation, as an example, when the virtual agent 100 takes in an input such as “show me red toy cars” from a user using a software application, the user may directly be directed to a page showing red toy cars. If the user had done this search on his own, he would have first seen results for toy cars, and would then filter them. Thus, in the absence of the virtual agent 100, more than one output page would have been displayed for one or more desire actions.

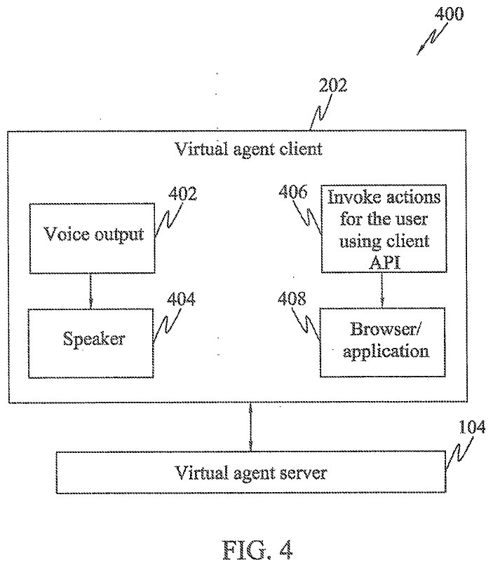

FIG. 4 depicts a diagram illustrating interactions between a virtual agent client 202 and a browser in the process of instantiating actions for a user, according to one or more implementations of the present disclosure. The virtual agent client 202 may invoke one or more actions on behalf of the user using the client application programming interface (API) as shown in step 406. The voice output at 402 may be delivered to the user by using an output device such as a speaker at step 404. For the above mapping, if the user says “Can you show me black shoes?”, the virtual agent client 202 Application Programming Interface that is implemented as a JavaScript and HTML snippet on the browser will fill the “search-box” with “black shoes” and click the “search-submit” button.

The virtual agent 100 may receive explicit inputs from the user of the software application and use these inputs to identify an action desired by the user to be performed and identify a context corresponding to the action. Further, based on the desired action, the virtual agent 100 may incorporate the context into the actions and execute one or more actions. Then it may generate a statement in case the action desired or the corresponding context are not clearly identified from the explicit input. Subsequently, the virtual agent 100 may output the statement in an audio format, and customize the audio and statement based on a profile of the user that has been stored by the virtual agent 100.

In an implementation, the virtual agent 100 may communicate with one or more external systems to complete actions requested by the user. Such actions may include a transaction of the user. As an example, for a dining business, the virtual agent 100 may communicate with an order system to place the dining order for the user by using his stored financial details. These may include one or more of a stored credit card, debit card or bank account, among others. The order system may include a Point of Sale (POS) system used by the external system to carry out transactions with the user. As an example, the POS system for a dining place such as a restaurant may have all menu items and their prices stored in a database. When the user orders one or more items from the menu, the relevant information may be retrieved from the database to generate a bill for the user. Further, the order may be placed after the user completes the transaction by paying for the ordered items.

The virtual agent 100 may contact external systems to complete any transaction of the user. In case the virtual agent 100 performs a secure transaction, the virtual agent 100 may be required to validate the user it is communicating with. The virtual agent 100 may compare the voice input of the user with an existing voice biometric of the user. Additionally, the virtual agent 100 may validate the phone number used by the user to ensure that the same phone number is associated with the user. As an example, validation may be required in a scenario where the virtual agent 100 may contact an order system to place the dining order for the user, using their stored credit card. The virtual agent 100 may also validate a user in case of one or more secure transactions related to transferring funds, buying plane tickets and making hotel reservation, among others.

In an implementation, the virtual agent 100 may compute a signature for the user's conversation style. The virtual agent 100 may analyse the user's speech using one or more algorithms. Additionally, as an additional verification, the speech analysis may be based on how the user uses frequently occurring words during the communication session with the virtual agent 100. Further, the virtual agent 100 may analyse the user's conversation patterns from one or more sources of the user's text or speech. The sources may include SMS, e-mail and social media platforms, among others, that are used by the user. Further, the virtual agent 100 may keep track of one or more patterns in the sentences that are frequently used by the user in their conversations.

In an implementation, in case there is a difference between the sentence pattern of the user determined from previous conversations, and the sentence pattern of the user in the current conversation, one or more security measures may be implemented by the virtual agent 100. As an example, the virtual agent 100 may determine that the user generally wishes a person by “Hello {Name}” from the user's conversations in their Email and Chat history. In case the user says “hey {Name}” the current communication session, the virtual agent 100 may tighten the security of the system.

In an implementation, the software comprising the virtual agent 100 may be embedded into the software application or the website of the small business. Alternatively, it may be provided as a separate service.

In an implementation, the virtual agent 100 may be configured to execute one or more actions along with a speech dialogue during the communication session with the user. As an example, the user may give the virtual agent 100 a verbal feedback such as “This dress is too dark and pricey” when they look at a dress they are browsing. The dialogue module 208 may understand this feedback and convert the feedback to a normalized query which the virtual agent server 104 may understand. In an implementation, a visual semantic embedding may be constructed by using one or more of the item characteristics such as description and pixel information of the image the person is looking at. Further, a normalized sentence may be constructed from the user's verbal utterances.

### Virtual Agent Configured to Handle Customer Service Calls

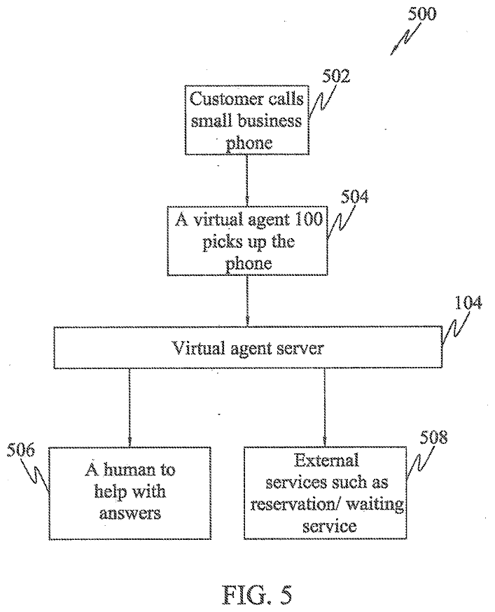

FIG. 5 depicts a diagram illustrating one or more exemplary workflows enabling a virtual agent client 202 (coupled to a virtual agent server 104) to handle customer service calls for a small business, per one or more implementations of the present disclosure. The virtual agent client 202 may answer questions about the business and help to book appointments for the businesses. To answer questions about the business, the virtual agent client 202 may rely on virtual agent server 104.

In an implementation, the virtual agent 100 may act as a virtual customer representative system and receive audio or text input from a user. The user may be identified from the audio or text input based on the conversational characteristics of the user, by comparing them with conversational characteristics of existing users. The virtual agent 100 may use the audio or text input to identify an action desired by the user and identify a context corresponding to the action. Further, it may enable the carrying out of the desired action in case the user is identified and authorized to carry out the desired action. Further, as discussed above, the audio output may be based on context derived from the current communication session as well as any previous communication sessions with the user.

In an implementation, as depicted in FIG. 5, the customer may call the phone of a small business for a product or a service as shown at step 502. The virtual agent 100 connected to that phone may receive the call as shown in step 504. Further, in case an uneasiness is detected in the user's voice as discussed below, the virtual agent server 104 may connect the customer to a human customer representative as depicted at step 506. Alternatively, it may connect the customer to an external service such as a reservation or a waiting service as shown at step 508. As an example, a customer calls a local restaurant and tries to place an order. The call will be picked up a virtual agent 100 who wishes the customer with the business name with a personalized voice. This may be done by routing the business phone number to a call centre operated by virtual agents 100.

The virtual agent 100 may generate audio outputs for the user where the content of the audio output depends on the content of the audio input and on information from the website got by crawling. The characteristics of the audio output may be customized on the identity of the user.

In an implementation, the voice context may also be used to determine an uneasiness score. The virtual agent 100 may evaluate a sense of uneasiness in the user's voice and/or text by processing their speech using the speech context. The virtual agent 100 may also evaluate the sentiment of the user during the communication session to detect a sense of uneasiness in the customer voice and try to connect him to a human to for further assistance in case the uneasiness score of the user crosses an uneasiness threshold. The human customer service representative may be able to further assist the user by clarifying his concerns. As an example, the user may say “I am not satisfied with your response. I want to speak to the manager”. In response, the virtual agent 100 may detect dissatisfaction or uneasiness in the voice input of the user and may ask the user whether they want to speak with a customer service representative or the manager as requested by the user.

In an implementation, the virtual agent 100 may include one or more predictive algorithms or machine learning classifier algorithms. These algorithms may be trained to detect one or more features in the user's voice input such as a difference in the voice amplitude of the current interaction and previous interaction. The algorithms may also be trained on the repetition of same words or repetition of words which are close when spelled out, among others. Further, the virtual agent 100 may use the uneasiness score to determine whether the user is dissatisfied with the virtual agent 100 to generate one or more courses of action. As an example, the user may say “I'm not understanding what you want are saying.” with a different voice amplitude. In this case, the virtual agent 100 may suggest the user to speak with a customer representative.

In an implementation, the voice input may be used to compute an urgency score which may be based on the speech characteristics of the application. The sentiment of the user may correspond to the urgency score. The urgency score of the user for accessing a service may be determined by predictive or machine learning methods using inputs including one or more of rate of speech (words/second), pitch of speech, use of words such as “rush” and “urgent”, among others. As an example, a user may say “I am extremely hungry and want food as soon as possible”. In response, the virtual agent 100 serving a small business may process the user's speech and determine that the user has used one or more keys words and/or tokens such as “extremely hungry” and “as soon as possible”. Further, the virtual agent 100 may talk to the user regarding quickly-made burgers available in the restaurant. The virtual agent 100 may also stress that it is immediately available for pickup, noting that the user wants to eat food urgently.

In an implementation, the urgency score may be used to determine or alter the sequence of actions executed by the virtual agent client 202. An action or suggestion which is urgent for the user may be executed before other actions. In an example, this urgency signal may be used to alter the ordering of the items in the spoken dialogue.

In an implementation, the visual semantic embedding may be constructed using a convolutional neural network. The convolutional neural network may be trained with one or more annotated images from Flickr and ecommerce items from the retailer. The virtual agent server 104 may take the visual semantic embedding, price filters from the client code and may search the catalogue to generate items that may match the user's interest. Further, the results may be displayed to the user and the virtual agent 100 may receive more feedback from the user. This feedback may then be used to suggest further items, until the user completes the transaction flow either through a purchase or by explicitly closing the application. Thus, the virtual agent 100 may act as a salesman for an ecommerce store to increase conversion in the software application or website.

In an implementation, a normalized sentence may be constructed using manual rules. As an example, in case the user says “this dress is too pricey”, the virtual agent 100 may convert the sentence to a query on the backend. The query may include information regarding the cost of the product. Further, the virtual agent 100 may collect further information such as current price information and applicable discounts, if any. In case discounts are available, the virtual agent 100 may decrease the price of the item by “X” $, where “X” may correspond to a discount. Subsequently, the virtual agent 100 may communicate the decreased or discounted price to the user.

In an implementation, the virtual agent 100 may be able to perform multiple actions for a user during a single conversation. As an example, in case the user says “Can you place an order for my regular shoes and socks”, the dialogue module 208 may send multiple actions to the context generation module 210. The actions may include placing an order for shoes and placing an order for socks. Further, the context generation module 210 may generate relevant responses for the user and the virtual agent client 202 on the browser may initiate the requested actions for the user.

In another implementation, the virtual agent server 104 may receive information regarding web-services for checkout through manual configuration or web service discovery mechanisms. Subsequently, the context generation module 210 may initiate one or more actions on the user's behalf. Further, it may communicate one or more notifications to the user with a customised message to acknowledge the performed actions. As an example, the virtual agent 100 may place an order for shoes and socks for the user as described in the example above. Subsequently, the virtual agent may communicate a notification message to the user which may state “I have ordered shoes and socks for you. You can expect them to be delivered to your home tomorrow.”

In an implementation, there may be a software application wherein a user may place a phone call to an organization to purchase a product or a service. Such organizations may include restaurants, supermarkets, dry-cleaners, among other organizations that may be contacted by the user. As an example, a user may call a local restaurant to place an order. The call may be picked up a virtual agent client 202 who may greet the user in a personalized voice with the business name. Further, the virtual agent 100 may provide any assistance needed by the user to complete their request. This may be done by routing the business phone number to a call centre operated by one or more virtual agents 100.

In an implementation, the virtual agent server 104 may rely on offline processes to collect knowledge about the business. The offline component of the virtual agent 100 may crawl one or more relevant small business website to collect data about the offerings of the business. This data may be stored in one or more databases. Further, the virtual agent server 104 may query the data. Subsequently, the virtual agent server 104 may construct one or more natural responses for the user.

In an implementation, the offline process may use one or more techniques such as pattern matching rules, entity name recognition techniques and/or deep learning techniques to extract information about the business and its offerings. Users may also manually add information about the business into the database. The offline component may also convert previous user service call sessions to textual question and answer sessions to extract further information about the businesses. This may be achieved by using regular expression parsing and entity name recognition techniques.

### Example Implementation

Referring to FIG. 7, the virtual agent client 202 and virtual agent server 104 may be integrated with a video streaming mobile application 700. At step 702, a user of the application 700 provides an audio input. The audio input may be provided by speaking into the smartphone. An example of the audio input may be “can you show me action movies”. The audio input provided by the user is received by the virtual agent client 202, which is residing on the user's smartphone and integrated with the application 700. It may be appreciated that the input provided by the user is not in a structured format, rather the input is in a natural language format. The virtual agent client 202 sends the user's input to the virtual agent server 104 at step 704. The input may be communicated to the server 104 is the audio format. Alternatively, the client 202 may convert the input into text format, and the text in natural language format may be communicated to the server 104. The server 104 processes the input to determine the intent of the user and identifies the action available in the application 700 that, correlates with the intent. As an example, the phrase “can you show me” is processed to identify that the intent of the user by said phrase is to search. The server 700 also identifies that for a search intent, the corresponding action on the application is to conduct a search action by providing a search query and activating the search button. The server 104 identifies that the search string for the intent is “action movies”. It may be noted that, in case the server 104 identifies that the action desired is search, but the string to be used is absent in the input, then the server 104, via the client 102, may probe the user to provide a voice (preferably) input with the string. The server 104, at step 706, sends instruction to the client 202 to activate the search button after populating the search box with “action movies”. The client 202, at step 708, populates the search box with “action movies”. It may be noted that, although in this example, the box that is visible on the user interface is shown to be populated with the search string, the client 202 may alternatively populate the search string at the backend associated with the search box. Once the search string is populated, the client 202 activates the search button, at step 710. The application 700 may bring up results as a consequence of these actions. The client 202, at step 712, may enable generation of an output (preferably voice) by the smartphone. The output may be, in this example, “showing action movies”.

### Virtual Agent for a Brick and Mortar Store

As discussed in the background earlier, while customers experience problems in their online engagement, brick and mortar stores have their own share of problems. In a brick and mortar store, products are stored in racks spread across the floor of the store which makes it difficult to locate products in the store. Locating products may require extra effort and time spent by the customers or store assistants, which results in inefficient utilization of time and resources.

A user may go to a retail store and have a question about the exact location of an item. The user may open a software application or browser on their phone which includes a virtual agent 100 to find the location and route. The user may ask the virtual agent 100 “Where are the apples?”. The virtual agent 100 may receive and process the customer's question to determine and share the required aisle information. Further, the virtual agent 100 may guide the user to the item's location using one or more route finding algorithms including Dijkstra's algorithm.

In an implementation, the virtual agent 100 may further include an image capturing device like a camera to take one or more images of items in a retail store. The virtual agent 100 may further include a processor to associate a set of location coordinates to one or more of the images that are captured by the camera. Further, it may associate at least one tag with that image, and receive an input from a user who is requesting for the location of an item. The processor may specify the location of the item within the retail store based on the associated tag and the set of coordinates associated with the captured images.

In an implementation, the camera may be mounted on a land vehicle like a robot or an aerial vehicle like a quadcopter or drone. The vehicle may travel around the retail store while the camera captures images of the items in the store. The vehicle may be configured to traverse at preconfigured times, or upon initiation by a user.

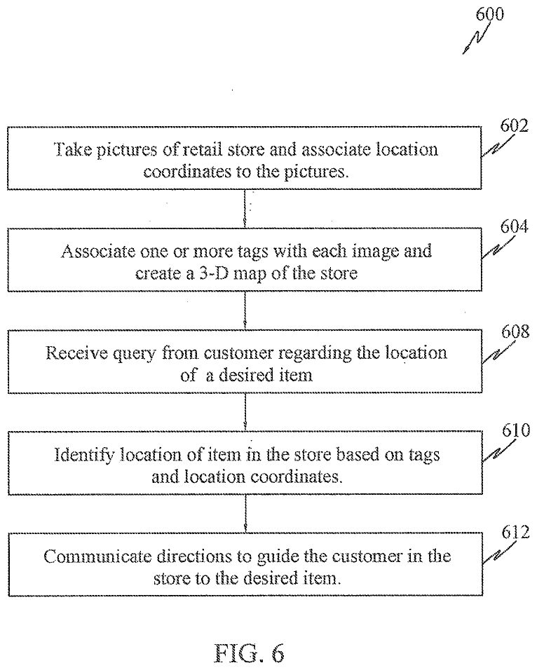

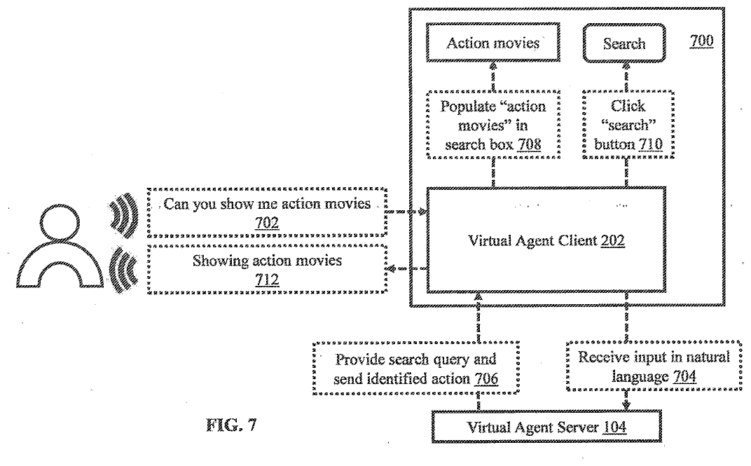

FIG. 6 depicts a flowchart 600 illustrating a virtual agent 100 helping a user in finding a physical route, in accordance with an implementation. In step 602, the camera may take one or pictures of items in the retail store. Further, the virtual agent 100 may associate one or more location coordinates to each of the pictures taken by the camera. The virtual agent 100 may associate each picture with one or more tags relevant to the picture. Further, the virtual agent server 100 may create a three-dimensional map or representation of the store as shown at step 604. Subsequently, the virtual agent 100 may communicate with a user and receive a query from the user regarding the location of one or more items desired by the user as shown at step 606. The virtual agent may use the associated tags and location coordinates to determine the position of the user's desired item as shown in step 608. Further, the virtual agent 100 may communicate with the user to provide directions to the desired item, as shown at step 610.

In an implementation, to give the user the location of the item, the virtual agent 100 may create a 3-dimensional representation of the retail store, and a map of x, y, z coordinates for each item, using an offline program to process the captured images. This may be done by an autonomous or semi manual quadcopter with a camera mounted on it. The quadcopter may take images of scanned items as it flies through the retail store, recording a set of three coordinates, namely, x, y, z coordinates of the positions of the item. The three coordinates may also be provided with respect to the layout of the retail store. The recorded image may be tagged with a set of coordinates based on the coordinates of the camera at the time of capturing the image. After recording the images and their x, y, z coordinates, a clustering algorithm such as k-means may be run on the characteristics of the images to group them and to generate a representative image position for the group. The quadcopter may run across the retail store multiple times to ensure maximum coverage of the inventory and increase accuracy of the positions for the items. The items in an image may be identified by the processor which may add more than one set of coordinates to a captured image based on the location of the identified items within each captured image.

In an implementation, the processor may identify items in a captured image and may add one or more tags to the image based on the identified items. The processor may use one or more images of items already stored in a database for comparison while identifying one or more items. The database may include one or more tags for one or more items in the retail store. One or more textual annotations for the images may be added by manual input or a combination of machine learning and predictive algorithms after determining the positions of the images. A combination of convolutional neural networks and recurrent neural networks may be used to generate a generic verbal description of the items in an algorithm implementation. The models may be trained on a retail data set comprising images and their textual descriptions collected through crowd sourcing methods to increase the accuracy of these models. The retailers generally group items in certain locations. The offline program after capturing the items may construct a hierarchy grouping for the items. The data for offline grouping may be generated manually or the information may be gathered by querying databases. As an example, let us say a retail salesman starts the quadcopter to scan the images every 2 days. The quadcopter scans the images of the items, aisle numbers and uses the image to textual algorithms to come up with a representation of items and their x, y, z coordinates in the store. The images and/or annotations may be used to query the retailer catalogue using image match and text match methods to get more metadata for the item.

In an implementation, this metadata may be parsed to extract the broader category hierarchy of the item and other metadata information such as synonyms for the item. The broader category metadata may be added as a data element which may be, queried by the virtual agent 100 to answer queries about the item.

In an implementation, the processor may specify the location of an item with respect to a reference location in the store. The reference locations may include one or more static locations such as a door, an entry, exit, or one or more dynamic locations such as a temporary shelf or a current location of the user. As an example, after generating the position map for each of the retail item, the virtual agent 100 of the retail store may welcome a customer and ask them what they require. The virtual agent 100 may help the customer by answering one or more questions related to price, brand and availability of an item, among others, by looking up the retail stores database. In case the customer asks the virtual agent 100 to take them to the exact location where they may find a certain item, for instance “strawberry jam”, the virtual agent 100 may use the three-dimensional Map of the items and descriptions that it constructed using the quadcopter, to find the location of the item and may guide the customer to the item's location from the customer's current position. It is to be noted that the three-dimensional Map of item and location information may be manually added into the database.

The present disclosure takes into consideration the preferences of users and generates suggestions which may be suitable to the user(s). Additionally, the system helps in suggestion and selection of products on a website or software application. Further, the system helps in speaking with customers and executing their orders. The system also helps customers to locate items in a brick and mortar store. Thus, the present disclosure as discussed in this document with respect to different embodiments will be advantageous at least in optimizing the process of selection of products and execution of actions of a user. Further, it is advantageous in providing better user experience and decreasing time and effort required by users. Additional advantages not listed may be understood by a person skilled in the art considering the embodiments disclosed above.

The embodiments disclose techniques used to solve problems in advertising with the help of virtual agent servers 800. A virtual agent server 800 can share advertisements with a user and can clarify the user's doubts about the advertisement. The virtual agent server 800 can converse with the user until all their doubts are cleared, and can place orders on behalf of the user. Further, the virtual agent server 800 can decide what type of advertisement to share with the user by considering the activities of the user. A common identifier can be used to aggregate and analyze the activities of the user.

In an implementation, a virtual agent server 800 may communicate advertisements to a user, receive inputs from the user and reply to the user. The virtual agent server 800 may try to clarify doubts of the user or complete a task for the user.

### Virtual Agent System

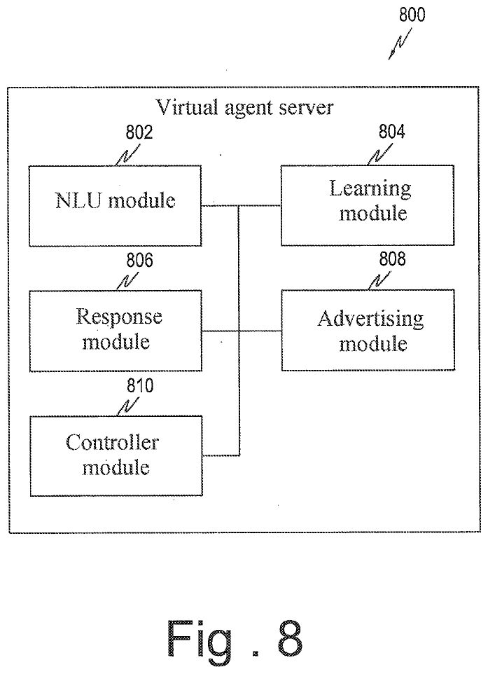

FIG. 8 depicts an exemplary architecture of a virtual agent server 800, in accordance with an embodiment. The virtual agent server 800 may include a Natural Language Understanding (NLU) module 802 to understand the speech of the user, a learning module 804, a response module 806 to determine responses for the user, an advertisement module 808 and a controller module 810.

In an implementation, the Natural Language Understanding Module 802 (hereafter called NLU module 802) may be used by the virtual agent server 100 to understand the natural speech of the user. In an implementation, the NLU module 802 may receive the user's natural speech as an input. This natural speech may be in the form of audio information or text in a natural language format. Further, the NLU module 802 may parse information from the received natural language speech to determine one or more pieces of information corresponding to the user from the speech of the user. The determined user information may include one or more of the user's desired action and context of the desired action, among others.

In an implementation, one or more inputs may be derived from one or more previous or current communication sessions between two or more among a first user (customer), a second user (customer service representative) and a virtual agent server 800.

In an implementation, the NLU module 802 may use machine learning classification and natural language processing techniques to determine the intent of the conversation. The NLU module 802 may also query a graph which may model conversations on an inverted index to figure out the search intent (as discussed below).

In an implementation, the NLU module 802 may determine the user's intent and use slot filling algorithms to determine different objects in the sentence. The slots associated with the application may be learnt by pattern matching or using neural network technique by feeding slot outputs and conversation inputs from previous interactions.

In an implementation, the learning module 804 may be used by the virtual agent server 800 to receive one or more sets of data to train on. Further, the learning module 804 may use the received training data to learn and store different types of speech or text responses for different situations faced by the virtual agent server 800 while communicating with the user.

In an implementation, the learning module 804 may be configured to receive and process one or more recordings of conversations between a customer service representative and a user. Further, the learning module 804 may convert the conversation between the user and customer service representative from natural speech format to device-readable format. The learning module 804 may use one or more speech-to-text recognition techniques to analyze the conversation for learning and store them in a database for future use. The stored conversations may be used to improve the intelligence of the virtual agent server 800 on a continuous basis by storing the conversations in a graph data structure on an inverted index for efficient retrieval in future conversations.

In an implementation, the learning module 804 may identify and store one or more conversation dialogues as parent nodes. These parent nodes may comprise dialogues spoken by the user that require a response from the virtual agent server 800. Further, the learning module 804 may identify and store one or more dialogues as child nodes which are used as responses corresponding to the one or more identified and stored parent nodes. Elaborating further, in an implementation, a dialogue may be defined by the learning module 804 as the smallest element in a conversation between a user and a virtual agent server 800 or a business organization. A dialogue may be represented by two nodes with an edge between them.

In an implementation, a graph may be constructed manually by an interaction designer, which may then be inserted on inverted index. In yet another implementation, in case a great amount of training data is available to the virtual agent server 800, a recurrent neural network may be trained on the interaction between the customer and the customer service representative by using the training data.

In an implementation, the response module 806 may be used by the virtual agent server 800 to generate one or more different responses to be shared with the user in different scenarios. A user may initiate a response to an advertisement which in turn may require a response from the virtual agent server 800 to the user.

In an implementation, the response module 806 may receive inputs from the NLU module 802 comprising the user's conversation and the context of the user's conversation. Further, the response module 806 may identify one or more recent dialogues in the current conversation that require a response from the virtual agent server 800 to the user. The response module 806 may retrieve one or more parent nodes to identify a parent node which is most suitable to the recent dialogue in the current conversation between the user and the virtual agent server 800. Subsequently, the response module 806 may retrieve one or more child nodes corresponding to the identified parent node. Further, the identified child nodes may be communicated to the user during the conversation.

In an implementation, the response module 806 may build a bipartite graph with a hierarchy of dialogues to converse with the user. The dialogues may be connected and branched away in case one or more new combinations arise during conversations across different communication platforms. The graph may be built on an inverted index data structure to support efficient text search.

In an implementation, as an example, an initiation sentence from the virtual agent server 800 such as “Hello, {Customer Name}! This is {Company}. How can I help you?” may be represented as the root node of a graph. The data in the node may comprise one or more placeholders for one or more of the user's name, and the business name, among others. The placeholders in the conversation for building the graph may be identified by looking for fuzzy string matches from the input dictionary comprising one or more inputs such as the business name, the customer name and the items served by the business, among others.

In yet another implementation, one or more Name Entity recognition techniques may be used to identify the labels in the input.

In an implementation, a node may be annotated with information regarding whether the user or the virtual agent server 800 was the speaker of the dialogue corresponding to that node. The node may also comprise one or more features such as semantic mappings of the sentence and vector computed using sentence2vec algorithm by training a Recurrent neural network on the domain that the software agent is trained for.

In an implementation, a different semantic response from the user may be used to create a child node for the parent node corresponding to the dialogue shared by the virtual agent server 800. The semantic equivalence to the existing nodes on the graph is achieved. In an implementation, the semantic equivalence of two nodes may be calculated by computing cosine similarity between the top results from one or more learn-to-rank algorithms, including, for example, Lambda Mart, borrowed from one or more search techniques after doing a first pass inexpensive ranking on the inverted index of the graph of conversation.

In an implementation, the result from a learn-to-rank algorithm with the highest score exceeding a certain threshold may be used as a representative for the user input. The semantic equivalence comparison and scoring may be done after tokenizing, stemming, normalizing and parametrizing (recognizing placeholders) the input query. Further, one or more slot filling algorithms may be used to parametrize the user responses. The slot filling algorithms may use HMM/CRF models to identify one or more part of speech tags associated with keywords and statistical methods to identify one or more relationships between words. In case there is a match to an existing dialogue from the user, the response module 806 may store the dialogue context of the existing dialogue instead of creating a new node. In case there is no match, a new node may be added to the node of the last conversation.

In an implementation, some dialogues may be questions with straightforward answers. As an example, consider a user asking a question to a virtual agent server 800 representing a restaurant:
User: “What is your specialty?”.
Virtual agent server 800: “Our specialty is Spicy Chicken Pad Kee Mow”.

In another implementation, a user may converse with a virtual agent server representing a shopping website:
User: “Is anything on sale?”
Virtual agent server 800: “Yes, there is a sale of 20% off on all electronic gadgets.”

These dialogues may be indexed on the graph as orphan parent-child relationships in the graph.

In an implementation, a change in context may be a common challenge while building a graph that may constantly learn. In case there is no change in the context, a node may be created as a child of the previous node. In case there is a change in the context, a new node may be needed which is different from the previous state in the graph. In an implementation, one or more classifiers such as a Bayesian or SVM Machine Learning classifier may be used to determine a change in context when the user talks to the customer service representative. The classifier may be trained on crowd sourced training data using one or more features. These features may include one or more of: number of tokens common to a current and previous task; and matching score percentage between the user's speech and the maximum score match of an existing dialogue. A different classifier may be trained for different domains to improve the accuracy of the classifier.

In an implementation, Neural Networks may be used by the virtual agent server 800 to implement personalisation in the conversation with the user. The virtual agent server 800 may be provided with training data comprising one or more stored conversations between two humans. Subsequently, one or more cluster algorithms identified online may be used to train one or more models with the training data received by the virtual agent server 800. Subsequently, one or more user features may be included in the model to accomplish personalization while conversing with the user.

In an implementation, one or more user profiles may be clustered into one or more macro groups to implement personalization to models in a recurrent neural network. An unsupervised clustering algorithm such as K-Means clustering may be used to accomplish this. Alternatively, manually curated clusters may be created based on one or more information about the user such as age group, location and gender of the user, among others. Further, the weight of the examples that had a positive conversion from the virtual agent server 800 may be boosted. In an implementation, this may be achieved by duplicating positive inputs in the training data. The positive inputs may be characterized by one or more pieces of information including the order price and satisfaction from the user, among others. Additionally, one or more user features such as age and gender can be added as an additional input for the Machine Learning models.

In an implementation, the idea of personalization in neural networks may not be specific to conversational customer interactions and may be used in one or more situations including building models which send automatic responses to emails. In an implementation, the graph on the inverted index may be used by a virtual agent server 800 to answer questions about the business. The virtual agent server 800 may start from the root node of the graph to greet the user during a conversation on one or more of a call, SMS or messenger. The user may respond to the greeting with a question about the business. Subsequently, the response module 106 may search for the closest match to the user's question by using techniques borrowed from information retrieval. In an implementation, this may be accomplished using an inverted index to look up possible matches for the user input using an in-expensive algorithm initially and then evaluating the matches with an expensive algorithm such as a Gradient Boosted Decision Tree. The response module 806 may run one or more stemming, tokenization and normalization algorithm on the input query to make sure that the input may be searched properly by the algorithms looking for match before hitting the inverted index.

In an implementation, the advertisement module 808 may be used by the virtual agent server 800 to identify one or more advertisements that the user may be interested in. Further, the advertisement module 808 may be used to communicate the identified advertisements with the user.

In an implementation, the advertisement module 808 may analyze user actions online and offline by collecting their search and browse actions on one or more websites such as FACEBOOK and GOOGLE, among other websites and web applications. Further, the advertisement module 808 may receive offline records from credit transactions.

In an implementation, an identifier for the user may include an email-id, username or a common identifier. This identifier may be used to aggregate information corresponding to one or more actions made by the user. The advertisement module 808 may use one or more big data technologies such as HADOOP, Map-reduce paradigm and one or more real time offline processing frameworks such as Apache KAFKA or Spark to aggregate information. For example, in an implementation, information corresponding to one or user actions may be transferred using Apache KAFKA, stored on HADOOP file system and Map-reduce paradigm may be used to aggregate the data points for a user.

In an implementation, search queries and websites used by the user may be analyzed to derive items the user is interested in. Additionally, advertisements may be customized before communicating the advertisement to the user. One or more placeholders present in the advertisement may be customized to include the user's information at run-time.

In an implementation, the aggregated actions of the user may be used to identify which stage the user is currently in, compared to the advertiser's objectives. For example, in case the user is browsing web pages of camera review sites by entering broad queries such as “best camera” or “camera reviews”, the virtual agent server 800 may determine that he is in the discovery stage.

In an implementation, the aggregated actions of the user may be obtained from one or more current or previous communication sessions involving the user, wherein the communication session was tracked.

In an implementation, the aggregated actions of the user may be obtained from one or more external sources, wherein the external source comprises one or more web applications used by the user or one or more databases comprising information about the user.

In an implementation, the virtual agent server 800 may provide a service to the user to help with completion of transaction after the user has viewed an advertisement and wishes to place an order. The virtual agent server 800 may share one or more advertisements with the user to monetize the transaction service. One or more advertisers may bid on keywords and user profiles similar to online advertisement platforms including Facebook and google ads.

In an implementation, the advertiser's messages for a natural language conversation may be crafted using manual curation. Taking an example of a retailer, the advertiser may use three stages of a purchase funnel. In the first stage, an interaction designer may model the conversation as a “discovery stage” where multiple choices corresponding to a particular type of product may be shown. In the second stage, individual products that the user may be interested in and information about the individual product may be shared with the user. In the third stage, a call for action can be shared with from the user. This call for action may comprise of an offer corresponding to the product which was communicated to the user in the second stage.

In an implementation, a Support Vector Machine learning classifier may be used to determine the conversation intent and stage in the purchase channel after training it with one or more features such as search keywords, domains and categories of the web pages visited by the user. Further, the conversational marketing may be modelled as a graph on an inverted index as discussed above. Additionally, the virtual agent server 800 may use one or more learn-to-rank algorithms such as Gradient Boosted Decision Tree to identify a match for the user context. Making customer interactions conversational by modelling it as a graph on an inverted index hosted on a machine may make the system work efficiently for millions of businesses.

An example of the three advertisement stages may be as follows:

In the first stage, the user may be searching for a broad type of product. The first stage advertisement may include multiple products with a message “Here are some {items}”, where {items} are the product names derived from the actions of the user. In case the user shows interest in the first stage advertisement, a second stage advertisement showing individual product(s) may be shared with the user, along with a message “See this {specific item} on Amazon”. In case the user shows further interest in the second stage advertisement, a third stage advertisement may be shared with the user which includes offers for the individual products shared in the second stage advertisement. Further, a message may be shared with the user stating: “Two days free shipping on {specific item} for the next 5 hours”.

Additionally, an advertising message may then be generated for the user shopping intent which includes one or more appropriate text, image, audio clip, video clip or hyperlink. The advertisement may be shared with the user when they visit a website or watch a video using one or more of an ad network, ad exchange or directly integrated-into-ad platform such as FACEBOOK and GOOGLE which have high traffic.

In an implementation, the controller module 810 may coordinate between other modules of the virtual agent server 800 to assist users in a customer service. Further, the controller module 810 may comprise instructions regarding the actions to be taken by the virtual agent server 800.

In an implementation, the controller module 810 may need to communicate with one or more different application programming interfaces to gain knowledge regarding external systems. As an example, the virtual agent server 800 may communicate with one external application to get customer information and with another external application to get customer service cases. The current application programming interface based communication has become complex to automate as it requires a developer of the software to create mapping between the user context and external application programming interfaces. Further, an application programming interface may be automated by using semantic understanding of the capabilities of the systems. This may be accomplished by creating a global registry of application programming interfaces, with annotations assigned to the parameters with synonyms of the keys which may make it easier for the consuming services to map the runtime context to the parameters. Alternatively, a universal language and a sequence of exchanges for associating input context to an external application programming interface may be created.

In an implementation, the global registry (also known as semantic registry) of application programming interfaces may be populated, updated, or enriched at least in part through automatic discovery of one or more application programming interfaces. The automatic discovery may be performed using one or more schema-based parsing techniques and web service discovery techniques. For example, the controller module 810 may retrieve and analyze interface definitions, service descriptions, parameter specifications, metadata, endpoint descriptions, executable function definitions, or capability descriptions associated with external systems. The schema-based parsing may process one or more machine-readable interface descriptions including OpenAPI specifications, Swagger definitions, Web Services Description Language (WSDL) documents, JavaScript Object Notation (JSON) schemas, function definitions, tool definitions, or other structured interface specifications. The discovered application programming interfaces, parameters, capabilities, and associated semantic information may be automatically incorporated into the global registry, thereby reducing manual configuration efforts and enabling dynamic integration with newly available external systems.

In an implementation, the virtual agent server 800 may be able to communicate one or more relevant advertisements to the user when the user is waiting on the completion of a task. In this case, the controller module 810 may determine whether to communicate an advertisement to the user. This may be done by starting another asynchronous thread/process to initiate the execution of the suggestion on behalf of the user. The virtual agent may use the current thread to deliver an advertisement. Simultaneously, the controller module 810 may communicate a message to the user regarding the execution of the suggestion.

As an example, the virtual agent server 800 may communicate the following message to the user: “I am confirming your order with the customer service of the restaurant OLIVE GARDEN. For your next special order, please consider “CALIFORNIA PIZZA KITCHEN”. They have introduced a new dish called Vegetarian Lasagna which you might like”. This communication may be an audio, video or a text advertisement.

As another example, in a retail store context, the customer may place an order. Further, the virtual agent server 800 may communicate the following message to the user: “I am confirming your order with Amazon. For your next purchase, please consider “Buyer's Best Electronics goods.”. They are offering a discount on BLUETOOTH speakers which you may like”.

In an implementation, the advertisement module 808 displays the advertiser's advertisement as follows: the advertisement module 808 may search through the advertiser database and load information corresponding to ads. Further, the advertisement module 108 may assign rank to the advertisements related to one or more of: revenue, preferences of the users, relevance to the user's desired action and to the context of the desired action. Subsequently, the advertisement module 808 may then communicate the advertisement to the user. In an embodiment, a learn to rank algorithm may be used to rank the search results.

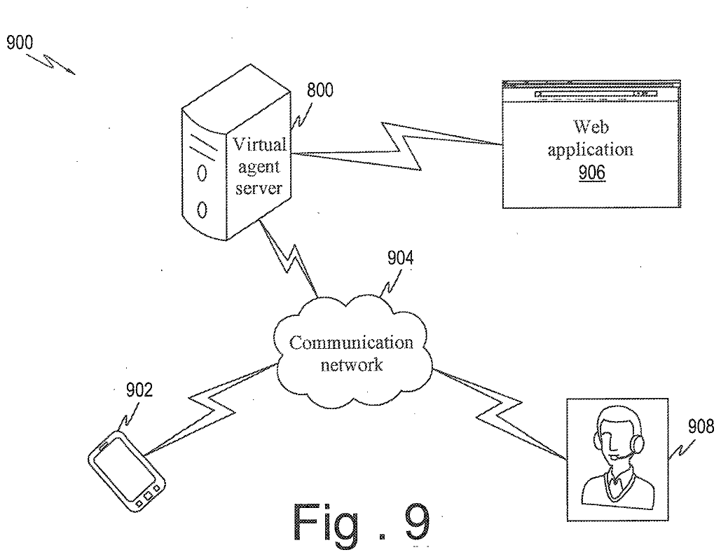

In an implementation, FIG. 9 depicts a system 900 comprising a virtual agent server 800 which may represent a web application 906 of a business. The virtual agent server 800 may communicate with a user through their user's mobile device 902 and using a short message service channel 904, a phone call channel or a social network 908.

In an implementation, the system 900 may track a conversation between the user and a web application 906. Further, the virtual agent server 800 may communicate an advertisement directed at the user as part of the conversation between the user and the web application 906. The virtual agent server 800 may receive one or more responses from the user and identify the response is for the advertisement. Further, the virtual agent server 800 may carry out at least one action if the user responded to the advertisement.

In an implementation, the user's mobile device 902 may include mobile phones, palmtops, PDAs, tablet PCs, notebook PCs, laptops and computers, among other computing devices. In an embodiment, the user's mobile device 902 may include any electronic device equipped with a browser to communicate with the virtual agent server 800. The user's mobile device 902 may belong to a user who may use it to communicate with the virtual agent server 800. In an implementation, the user's mobile device 902 communicate with the virtual agent server 800 and share inputs related to the user with the virtual agent server 800.

In an implementation, the virtual agent server 800 may be implemented in the form of one or more processors with a memory coupled to the one or more processors with one or more communication interfaces. The virtual agent server 800 may communicate with one or more external sources and one or more users' mobile devices 902 through a short message service channel. It may be noted that some of the functionality of the virtual agent server 800 may be implemented in the user's mobile device 902.

The system 900 may enable a computing system to converse with a human, wherein the system comprises a plurality of nodes. In an implementation, a first set of nodes may represent statements that may be made by a human, and a second set of nodes may represent statements that may be made by the computing system. The first set of nodes and the second set of nodes may be interconnected such that the interconnection enables the system 900 to select at least one of the statements represented by the second set of nodes, based on a statement from the human, which is mapped to one of the statements represented by first set of nodes.

In an implementation, at least one of the first set of nodes may be directly connected to a plurality of second set of nodes.

In an implementation, the system may be configured to select one or more among the second set of nodes, as a response to a statement represented by one of the first set of nodes to which the second set of nodes is directly connected. The second set of nodes may be selected based on a path navigated to reach the first set of nodes to which the second set of nodes is directly connected.

In an implementation, the system may be configured to enable a customer service representative to converse with the human in case a statement made by the human is not mapped to any of the first set of nodes.

In an implementation, the system may be configured to enable a customer representative to converse with the human in case a statement made by the human is mapped to one of the first set of nodes, which is not connected to any of the second set of nodes at a lower hierarchy.

In an implementation, the system may be configured to generate the first set of nodes and the second set of nodes by processing one or more learning data. In an implementation, the learning data may comprise conversation data between a first category of humans and a second category of humans. Further, the system 900 may be configured to build the interconnection by processing the learning data.

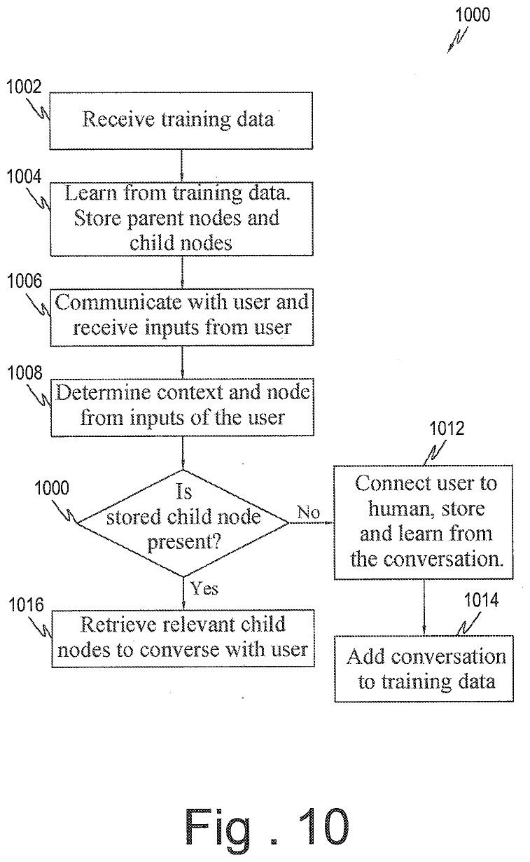

In an implementation, FIG. 10 depicts a flowchart of an exemplary method 1000 for interactive advertisement with a user, in accordance with an embodiment. In an implementation, the virtual agent server 800 may receive one or more sets of training data as shown at step 1002. The training data may be processed as discussed above. Subsequently, the virtual agent server 800 may learn how to build a conversation by using the training data. Further, one or more parent nodes and their corresponding child nodes may be stored in a database as shown at step 1004. The parent node may represent a dialogue and the child node may represent the response dialogue corresponding to the dialogue stored in the parent node.

In an implementation, the virtual agent server 800 may communicate one or more advertisements to the user. In case the user shows an interest, they may respond to the advertisement. The inputs may be received by the virtual agent server 800 as shown at step 1006. Further, the virtual agent server 800 may understand the speech of the user by converting it into text and determining a context of the conversation with the user. Further, the virtual agent server 800 may try to determine one or more dialogues that may be similar to the stored parent nodes as shown at step 1008. Subsequently, the virtual agent server 800 may retrieve one or more child nodes corresponding to the determined parent node as shown at step 1010. In case the virtual agent server 800 has determined that there were no stored child nodes, building further conversation with the user may not be possible. Hence, at step 1012, the virtual agent server 800 may connect the user to a human being. This human may be a company representative or a customer service representative, among others. The conversation between the user and the human may be processed by the virtual agent server 800 for processing and learning. Further, the conversation may be added to the training data as shown at step 1014.

In case the virtual agent server 800 has determined the presence of a stored child node, it may be retrieved and the dialogue corresponding to that node may be communicated from the virtual agent server 800 to the user.

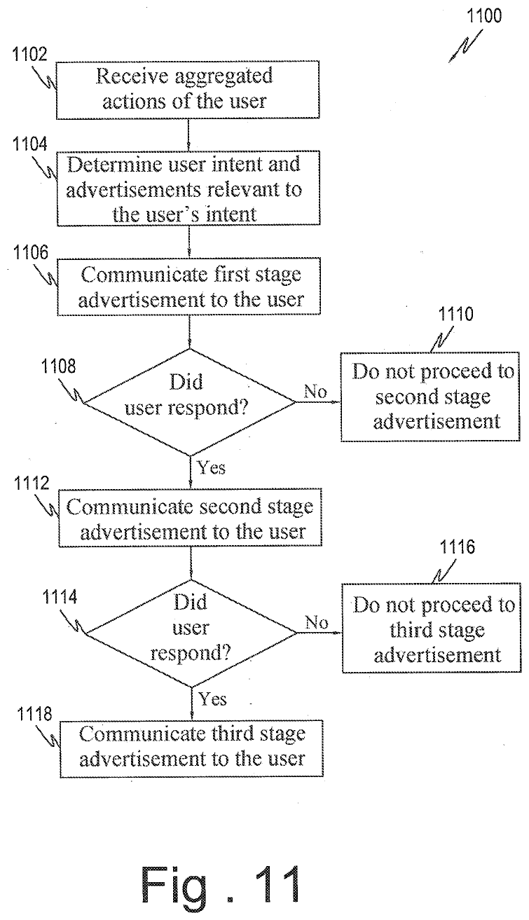

In an implementation, FIG. 11 depicts a flowchart of an exemplary method 1100 for communicating advertisements to a user, in accordance with an embodiment. As depicted at step 1102, the virtual agent server 800 may receive one or more aggregated actions of the user from one or more sources. Subsequently, the virtual agent server 800 may determine user intent based on the received aggregated actions of the user. Further, the virtual agent server 800 may communicate with one or more databases comprising advertisements to identify one or more advertisements that may be relevant to the user's intent as shown at step 1104.

At step 1106, the first stage advertisement may be communicated to the user. Further, at step 1108, the virtual agent server 800 may determine whether the user responded to the first stage advertisement. In case the user didn't, the virtual agent server 800 may determine not to proceed to communicate a second stage advertisement to the user as shown in step 1110.

In case the user did respond to the first stage advertisement, the virtual agent server 800 may determine to communicate the second stage advertisement to the user as shown at step 1112.

Further, at step 1114, the virtual agent server 800 may determine whether the user has responded to the second stage advertisement. In case the user didn't, the virtual agent server 800 may determine not to proceed to communicate the third stage advertisement to the user as shown at step 1116.

In case the user did respond to the second stage advertisement, the virtual agent server 800 may determine to communicate a third stage advertisement to the user as shown at step 1118.

In an implementation, the exemplary method 1000 as described above may be used by a virtual agent server 800 in a customer service context. The virtual agent server 800 may use method 1000 to act as a customer service representative and hold conversations with a user.

In an implementation, the user may be browsing online on one or more websites. Further, the user may be shown an advertisement, which may need to be encoded with information about the user to make the advertisement actionable for an organization. Further, the identity of the user may be encrypted to protect the user's privacy. Such encryption may be accomplished by using one or more methods such as one way hashes or public private key encryption mechanisms.

In an implementation, the virtual agent server 800 may identify the user by looking up one or more stored mapping information in one or more encrypted mapping between the user and the encrypted id in case the user starts to interact with the advertisement generated by the virtual agent server 800 on the social networks 910 and other external applications. The interaction with the user may be then personalized and one or more actions may be triggered for that advertisement.

In an implementation, the user information may include one or more of email-id, phone number, first name and last name combination. Further, the user information may be matched with similar identifiers on one or more social networks 910 and other external applications, among others. One or more user information may be exchanged with the social networks 810 and other external applications to make sure that the privacy of the user is protected. This may be achieved by using encrypted identifiers constructed from one or more user information.

In an implementation, the advertisement may be one or more of an actionable display, conversation or a bot advertisement, wherein the user may start interacting with the virtual agent server 800.

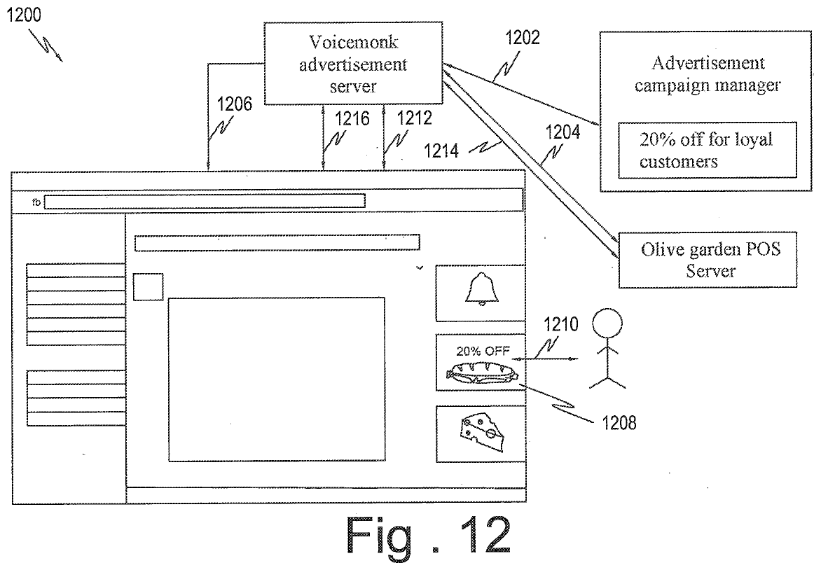

FIG. 12 depicts a flow diagram of an exemplary method 1200 for communicating advertisements to a user through actionable marketing, in accordance with an embodiment. As an example, Voicemonk advertisement server may provide a conversational advertisement service to an Italian Restaurant “OLIVE GARDEN”. The Voicemonk advertisement server may communicate with a website being browsed by the user, an advertisement campaign manager and an OLIVE GARDEN Point of Sale (POS) server as shown in the figure.

In an implementation, a user “Tom” may be a regular customer of OLIVE GARDEN, who has not visited the restaurant recently. The Voicemonk advertisement server may be responsible for engaging Tom to make him visit the restaurant. The Voicemonk advertisement server may display an actionable advertisement by using one or more user information related to “Tom” to accomplish this. Hence, the Voicemonk advertisement server may communicate with the advertisement campaign manager regarding an advertisement which may include a 20% discount for loyal customers, as shown at step 1202. Further, the Voicemonk advertisement server may communicate with the OLIVE GARDEN POS server regarding information details of loyal customers, as shown at step 1204.

Further, in an implementation, the Voicemonk advertisement server may locate Tom and match the id information of loyal customer Tom as shown at step 1206. Subsequently, the Voicemonk advertisement server may display an advertisement to Tom through the website or application that is being used by Tom. The advertisement may include a 20% off link only valid for Tom, as shown in the website at step 1208: “It has been a while since you last came to OLIVE GARDEN. We are offering a 20% discount for today's special, ‘Italian Lasagna’ to loyal customers like you. Please click on this ad to accept the offer and place an order.”

In an implementation, Tom may click on the order as shown at step 1210. Further, as shown at step 1212, the Voicemonk advertisement server may be able to identify the user using the method described above. Subsequently, the virtual agent server 800 may communicate Tom's order at the OLIVE GARDEN POS server, as shown at step 1214. Further, the Voicemonk advertisement server may communicate with Tom in a personalised natural language conversation as shown at step 1216. The conversation may include calling up the restaurant, making reservations, clearing one or more doubts related to an order, and placing an order at the restaurant by calling the external Point of Sale Application Programming Interface, among others.

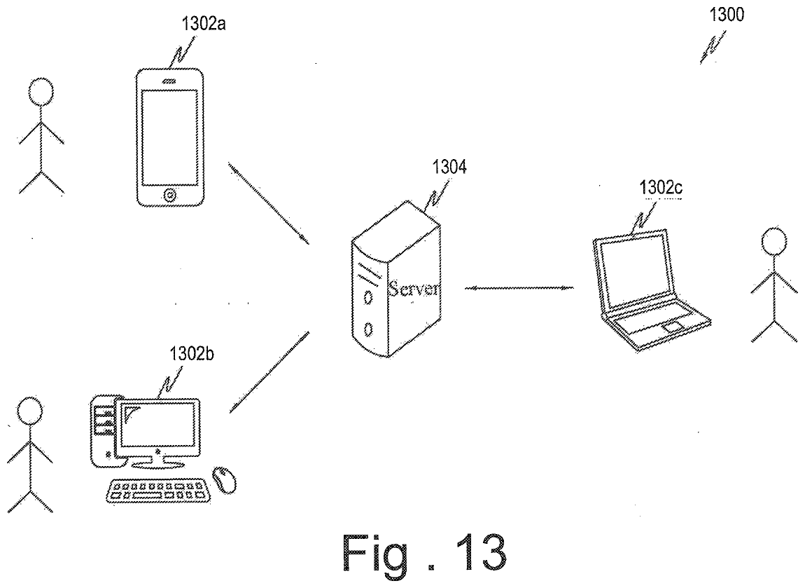

FIG. 13 illustrates an exemplary architecture of a system 1300 for generating search tokens for a user, in accordance with an embodiment. The system 1300 includes a server 1304 that communicates with one or more users using their data processing devices 1302 a-c. User A may operate their device 1302 a, namely, their mobile phone; user B may operate their device 1302 b which is a desktop computer and user C may operate their device 1302 c which is a laptop.

The device 1302 (also referred to as a device of the user) may include mobile phones, palmtops, PDAs, tablet PCs, notebook PCs, laptops and computers, among other computing devices. In an embodiment, the device 1302 may include any electronic device equipped with a browser to communicate with the server 1304. The device 1302 may be used by the user to communicate with other users. The device 1302 may also include one or more input and output components such as a microphone, keypad, speaker and display, among others.

The server 1304 may be implemented in the form of one or more processors with a memory coupled to the one or more processors. The server 1304 may be implemented as appropriate in hardware, computer-executable instructions, firmware, or combinations thereof. Computer-executable instructions or firmware implementations of the server 1304 may include computer-executable or machine-executable instructions written in any suitable programming language to perform the various functions described. Further, the server 1304 may communicate with one or more external sources and one or more user's devices 1302 through the communication module 1402.

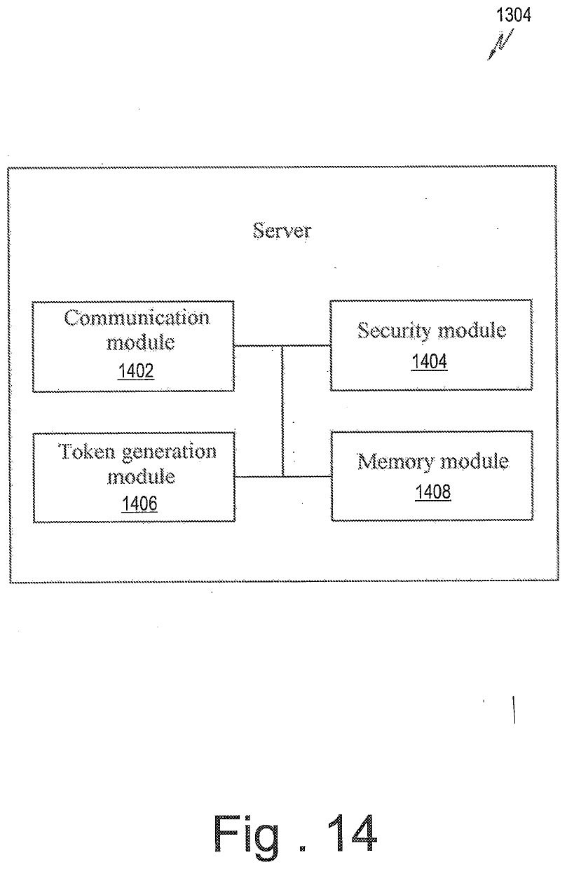

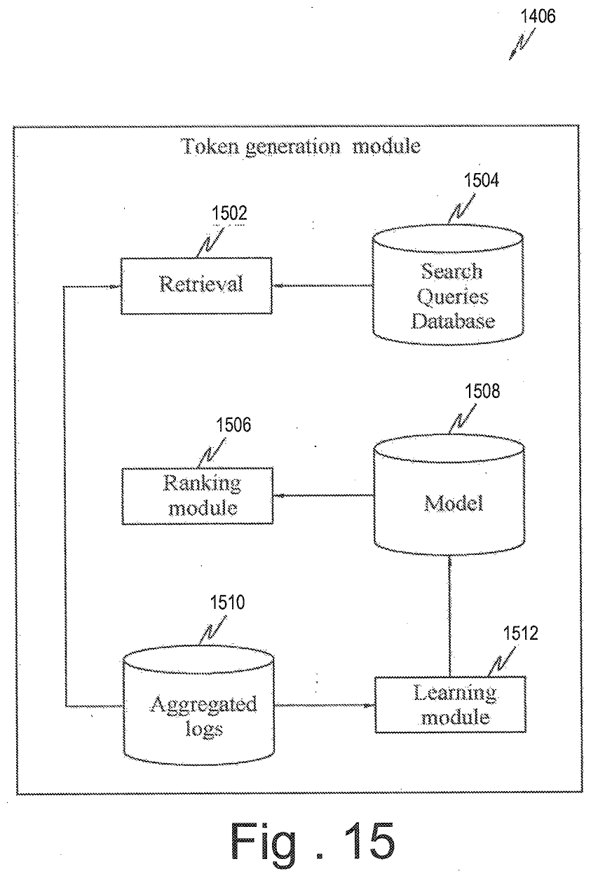

FIG. 14 illustrates an exemplary block diagram 1400 of a server 1304, in accordance with an embodiment.

In an embodiment, the server 1304 comprises a communication module 1402, a security module 1404, a token generation module 1406 and a memory module 1408.

In an embodiment, the communication module 1402 may provide an interface between the server 1304 and one or more users' devices 1302 a-c. The communication module 1402 may support both wired and wireless protocols. Data in the form of electronic, electromagnetic, optical signals and other signals may be transferred via the communication module 1402. Further, the communication module 1402 may be present for different technologies including WLAN, LTE and GPS, among others.

In an embodiment, the security module 1404 may be configured to implement one or more security protocols and/or applications in order to protect one or more data stored or transmitted by the system 1300.

In an embodiment, the token generation module 1406 may be configured to include one or more modules that may be responsible for generating one or more search tokens related to the user.

In an embodiment, the memory module 1408 may be implemented in the form of a primary and a secondary memory. The memory module 1408 may store additional data and program instructions that are loadable and executable on the server 1304, as well as data generated during the execution of these programs. Further, the memory module 1408 may be volatile memory, such as random-access memory and/or a disk drive, or non-volatile memory. The memory module 1404 may further include one or more removable memory such as a Compact Flash card, Memory Stick, Smart Media, Multimedia Card, Secure Digital memory, databases or any other memory storage that exists currently or may exist in the future.

FIG. 15 illustrates an exemplary block diagram 1500 of a token generation module 1406 for the system 1300, in accordance with an embodiment. The token generation module 1406 includes a retrieval module 1502, a search queries database 1504, a ranking module 1506, a model database 1508, aggregated logs 1510 and a learning module 1512.

In an embodiment, the retrieval module 1502 may be configured to implement one or more machine-learning models and/or human-defined rules. The retrieval module 1502 may determine a list of search queries after processing one or more inputs including data related to the user and user behavior profile. The retrieval module 1502 may communicate the retrieved search queries to one or more modules present in the system 1300.

In an embodiment, the search queries database 1504 may comprise one or more search queries related to one or more topics that the user may be interested in. The retrieval module 1502 may communicate one or more search queries related to one or more topics to the ranking module 1506.

In an embodiment, the ranking module 1506 may be a module comprising a deep feed forward neural network, used to rank one or more search queries according to the probability of being used/popular with the user. The deep feed forward neural network may compute a “tan [h]” score on one or more input features in order to rank the items.

In an embodiment, one or more input features for the ranking module 1506 may comprise one or more of word embeddings of search tokens, aggregated behavior, location of the user or demographic information of the user.

In an embodiment, when a user conducts online activity, one or more search queries in the form of one or more search tokens may be generated. The user's actions, queries and impressions may be recorded into the aggregated logs 1510 as training data for the learning module 1512.

In an embodiment, the learning module 1512 may comprise one or more machine learning and/or artificial intelligence methods that may be trained with one or more input data to achieve a certain task. The input data may include one or more of user actions, search queries or user impressions, which may be communicated as training data to the learning module 1512.

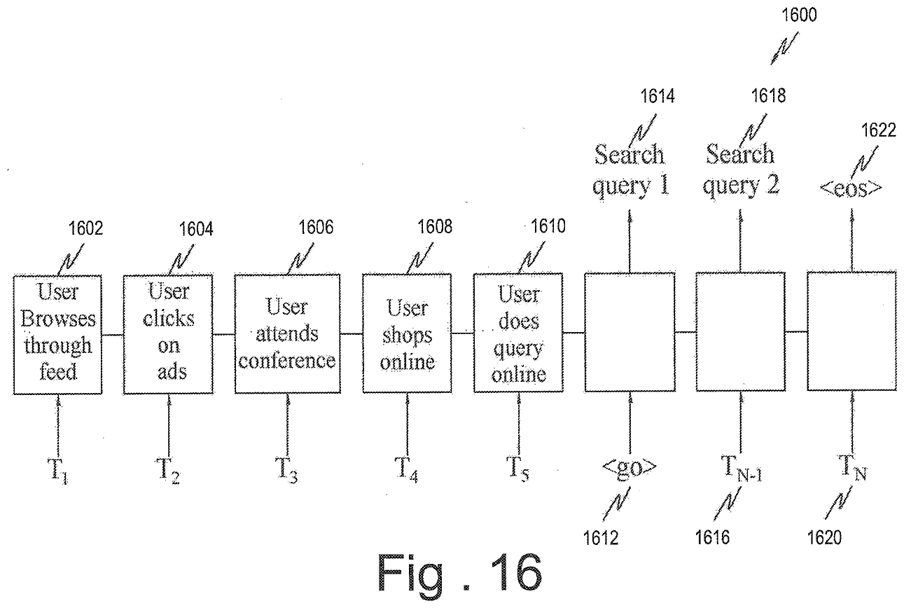

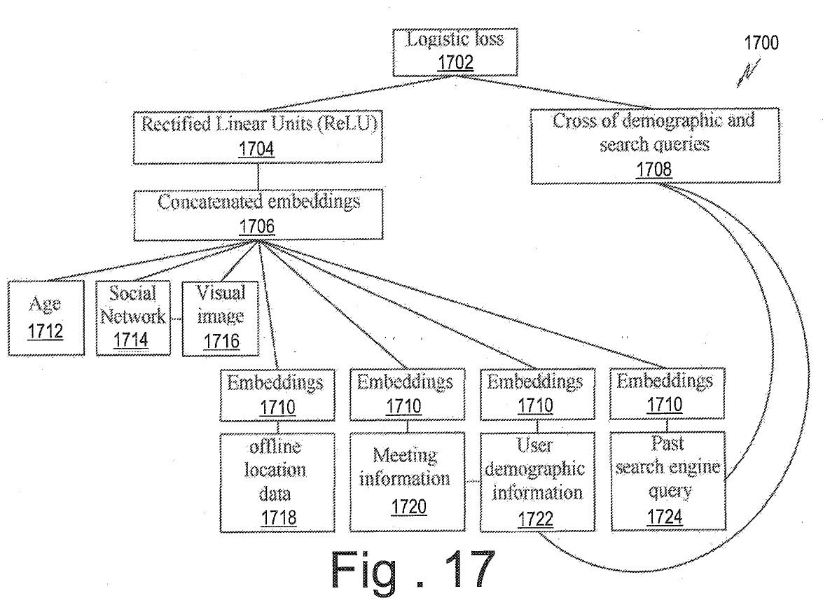

FIG. 16 illustrates an exemplary block diagram 1600 for a behavior-to-search model for the system 1300, in accordance with an embodiment. This figure depicts the inputs and outputs of the various stages in the generation of search tokens for a user.

In an embodiment, the behavior-to-search algorithm depicted in FIG. 16 may comprise two Recurrent Neural Networks (RNN). The first RNN may comprise an encoder that may process the input data. The second RNN may comprise a decoder that may generate the output search tokens. The behavior-to-search model may predict one or more follow up queries that the users may type onto a search engine after experiencing one or more events.

In an embodiment, the behavior-to-search algorithm may receive training data for the aggregated user behavior and search query from multiple applications as follows. The input may include one or more data from a digital social platform viewed by the user, as depicted in step 1602. The input may include an advertisement feed that was viewed by the user as depicted in step 1604. The input may include meeting information and geographical information related to one or more offline events attended by the user, as depicted in step 1606. Another input may include one or more websites, items, services and brands that the user viewed while shopping online, as depicted at step 1608. Another input may include one or more online queries entered by the user into a search engine, and the subsequent websites, articles and information viewed by the user, as depicted at step 1610. Further, a ‘go’ signal may be entered as an input in order to initiate the generation of the search tokens, as depicted at step 1612. Thus, the RNN may generate the first search token, ‘search query 1’, as depicted at step 1614 and a second search token ‘search query 2’, as shown in step 1618. It is to be noted that the behavior-to-search model may generate more than two search tokens, according to the inputs and computation of the model. The time series TN-1 may be entered as shown at step 1616 and TN may be entered as shown at step 1620. The signal ‘EOS’ may depict the end of the output computation, as shown at step 1622.

FIG. 17 illustrates an exemplary block diagram 1700 for a wide and deep neural network for the system 1300, in accordance with an embodiment. One or more training data may be entered as an input into one or more wide and deep neural networks to gather and rank web search queries. The wide and deep neural network may be used to focus on one or more different information elements to generate the search tokens. Further, the wide and deep neural network may be used for the accumulation and ranking of one or more search queries determined by the behavior-to-search neural network model.

In an embodiment, the input data for FIG. 17 may comprise one or more data related to the user including one or more of age 1712, social network 1714 used by the user, visual images 1716 viewed by the user, offline location data 1718 of the user, meeting information 1720 of the user, user demographic information 1722, or past search engine query 1724. The embeddings 1710 vector of one or more of these input data may be determined and subsequently concatenated with one or more of the other features available to the system 1300, to create concatenated embeddings 1706. The embeddings may then be communicated to one or more Rectified linear units (ReLU) 1704 layers, which is similar to a ramp function. The output of the Rectified linear units (ReLU) 1704 may be trained to optimize the logistic loss on predicting embeddings for one or more search tokens.

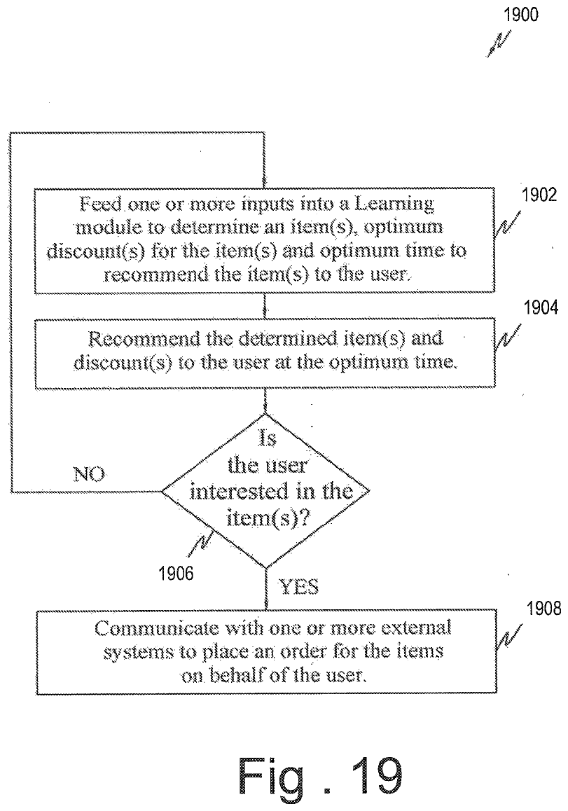

FIG. 19 illustrates an exemplary flow diagram 1900 depicting a method for generating a hyper-personalized marketing message for the system 1300, in accordance with an embodiment.

In an embodiment, according to step 1902, the system 1300 may feed one or more inputs into a learning module to determine one or more item(s), optimum discount(s) for the item(s) and optimum time to recommend the item(s) to the user. Further, the system 1300 may recommend the determined items and discounts to the user at the optimum time, as shown at step 1904. The system 1300 may then determine whether the user is interested in the items, as shown at step 1906. In case the user is not interested in the recommended items, the system 1300 may proceed to step 1902 to determine one or more other items that the user may be interested in. Further, in case the user was interested in the item, the system 1300 may communicate with one or more external systems to place an order for the items on behalf of the user, as shown at step 1908.

In an embodiment, the system 1300 may collect one or more user data to build a user profile vector using which, customized search tokens can be generated for a particular user. The search tokens may comprise items or topics of interest to the user. Thus, the search tokens may be used for a number of applications such as a) generating content articles for a user; and b) advertisement monetization.

### Data Enrichment for Deep Learning Algorithms

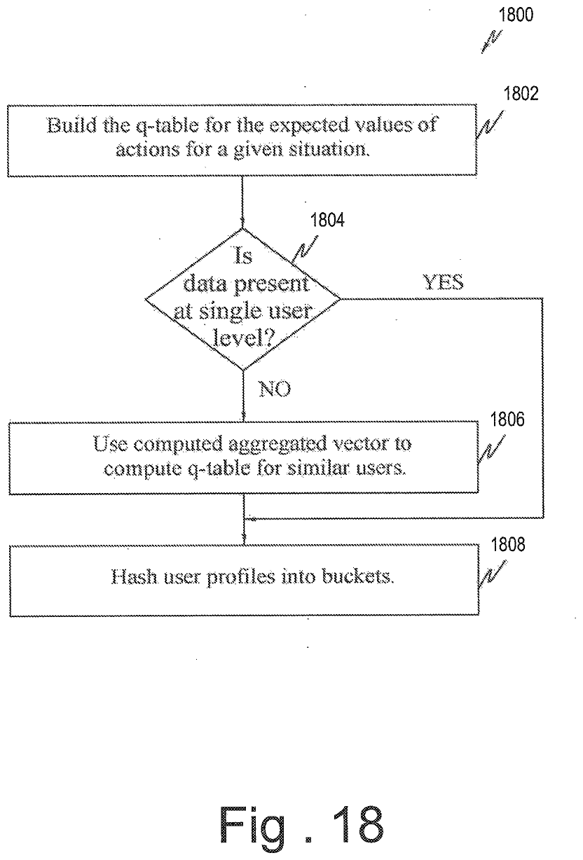

FIG. 18 illustrates an exemplary flow diagram 1800 depicting a method for generating aggregated user behavior using the system 1300, in accordance with an embodiment.

In an embodiment, a q-table may be built for the expected values of one or more actions for a given situation, as shown at step 1802. Further, the system 1300 may receive one or more inputs from the user vector and centroid vector of the user cluster using one or more aggregated profiles, as shown in step 1804. The system 1300 may then use the computed aggregated vectors to compute similar users, and use actions from one or more similar users to build the values of the q-table for the user, as shown at step 1806. Subsequently, the system 1300 may hash one or more use profiles into one or more buckets, as shown at step 1808.

In an embodiment, for some users, there may be a lack of historic data at a user level which is required to determine the expected value of an advertisement/content article to the user. In this case, data derived from interactions between similar users and generated ads may be used for generating search tokens for the user. Thus, the system 1300 may determine an aggregated user profile from multiple online and offline sources and further use the aggregated user profile to generate search tokens for a similar user.

In an embodiment, one or more of an aggregated profile vector, previous purchase data or one or more item vectors may be fed into a Deep Reinforcement Learning algorithm to determine one or more items that may be of interest to the user. These items may be recommended to the user in a hyper personalized marketing message.

In an embodiment, an end-to-end training algorithm such as Deep Reinforcement Learning/Deep Neural Net Supervised algorithm may be used to predict one or more features including timing of the advertisement, recommended item or user segment for the actionable marketing message described above.

In an embodiment, one or more recommendation algorithms including Collaborative Filtering algorithm leveraging one or more of previous clicks, order transactions or aggregated user behavior profiles may be used to determine similar item recommendations for the user.

In an embodiment, the Deep Reinforcement algorithm may build a value table or a q-table for the expected values of actions at a given state and previous actions/interactions between the user and the content articles. To build the value table or the q-table, data may not be available for each user. In this case, the aggregated vector may be to be computed for one or more similar users. Subsequently, one or more actions from similar users crossing a certain similarity threshold may be used to build the values of the q-table for the user.

In an embodiment, the aggregated user profile vector may be used in one or more collaborative filtering algorithms as an additional variable to generate one or more recommendations and content articles for the user.

In an embodiment, the recommendations may include one or more of similar items or other recommendations on the websites seen by the user.

### Generating Search Tokens

In an embodiment, as an example, user A may use their mobile phone 1302 a, user B may use their desktop computer 1302 b and user C may use their laptop 1302 c as depicted in FIG. 13. The server 1304 may comprise one or more processors operable to receive and store one or more user information related to one or more users in a user database. One or more external data may be received from one or more external sources such as e-commerce websites, social media networks or databases, among others. Further, the server 1304 may identify one or more profiles and/or accounts of the user on one or more digital platforms. The server 1304 may then collect and store one or more information related to one or more activities of the user on the digital platforms and in external systems, in the user database. Subsequently, the server 1304 may build a user profile vector to characterize the user's behavior. Further, the server 1304 may process the user profile vector with the help of a learning module 1512 in order to derive one or more search tokens and rank the search tokens to identify one or more content that is of interest to the user.

As an example, the user may have looked at one or more pictures of chocolate cakes on a digital social platform. The server 1304 may identify and/or verify the user's profile and/or virtual account(s) using one or more stored or external data to confirm the identity of the user. Further, the server 1304 may collect and store information related to the images viewed by the user on the digital social platform. The server 1304 may then use the learning module 1512 to build a user profile vector to derive one or more search tokens. Further, the server 1304 may rank the search tokens to identify one or more content that is of interest to the user. The topmost results in the search tokens may include content related to chocolate cake such as “Best chocolate cake”, “Buy chocolate cakes online now” and “Get chocolate cake delivered to your doorstep”, among others. The server 1304 may contact one or more external systems that are related to the content. Thereafter, the server 1304 may suggest or recommend chocolate cakes to the user by displaying one or more images or videos of a chocolate cake from a particular chocolate cake company called “Cake Zone” to the user. Further, the server 1304 may communicate one or more of advertisement, notice, a suggestion or an actionable recommendation to the user. Thus, the user may follow up on the content of the search tokens generated by the learning module 1512 of the server 1304.

In an embodiment, the system 1300, in particular, the server 1304 may build the user's user profile vector by processing word tokens derived from one or more of a social network, previous search engine queries, offline location data, meeting information, user demographic information, vectors for the images that the user sees, or the time associated with each event, among others. The word tokens may comprise words or phrases related to the content viewed by the user.

In an embodiment, the user profile vector may be used to train one or more learning modules to generate one or more search tokens. The search tokens may comprise words/phrases that are predicted to be of interest to the user.

In an embodiment, the server 1304 may generate the search tokens using Machine Learning (ML) algorithms and rule-based algorithms. As an example, in an embodiment an inverted index may be built, comprising search queries annotated with broad level categories from one or more users. A Latent Dirichlet allocation (LDA) algorithm and/or manually annotated rules may be used to construct one or more broad level categories from the aggregated user behavior. These broad level categories may then be used to gather all the possible search queries, which may be communicated to other modules as search tokens.

In an embodiment, the retrieval module 1502 may communicate the retrieved search queries to the ranking module 1506, which may use one or more ranking methods to rank the search queries. Further, the ranking module 306 may rank the search queries according to their scores.

The recommendation algorithm may comprise a two-step process. In the first step, possible search tokens may be generated. In the second step, the search tokens may be ranked and the top ‘n’ selected search tokens may be recommended to the user. The search queries relate to possible queries that the user may browse online.

In an embodiment, the generation of search tokens may be implemented in three stages. In the first stage, one or more input data related to the user may be gathered. Further, in the second step, the ranking module 1506 may use one or more generic or inexpensive ranking functions to rank the results. Optionally, in the third step, the ranking module 1506 may use a more specific or expensive ranking system for the same.

In an embodiment, the server 1304 may process the search token(s) using one or more ranking modules 1506 and rank them according to their effectiveness on the user.

In an embodiment, the search tokens may be derived using a behavior-to-search algorithm including one or more of attention mechanism or external memory.

In an embodiment, the attention mechanism may be used to focus on salient data parts, such as focusing on a single part of the provided data subset at a time. It may also be used as an approach for memory addressing. A conventional sequence-to-sequence model may reduce its input into a single vector and then expand it to generate the output. However, the system 1300 may enhance this method by using the attention mechanism. The attention mechanism may allow the input-processing encoder module to pass along information regarding each data it may process. Further, the attention mechanism may allow the output-generating decoder module to focus on any relevant data.

In an embodiment, using memory mechanism may provide data storage over a period of time.

In an embodiment, each box in FIG. 16 may represent an RNN cell with an attention mechanism capable of retaining memory, such as, for example, a gated recurrent unit (GRU) or a long short-term memory (LSTM) cell. The encoder and the decoder may share weights or use different sets of parameters. Every input transmitted into the RNN cells may be encoded into a fixed-size state vector which may be passed on to the decoder.

In an embodiment, the LSTM cell may include one or more cells that each include an input gate, a forget gate, and an output gate that may allow the cell to store previous states for the cell. This LSTM cell may be used in generating a current output or it may be provided to other components of the LSTM neural network.

In an embodiment, as an example, the encoder cells may use the user behavior profile as an input sequence. Further, the encoder cells may process and output one or more titles of newly crawled data as a concatenation of word vectors (through an average of word vectors) to predict one or more information search queries. The decoder cell may produce one or more search tokens as long as the <EOS> (end of signal) token is not created. Once the <EOS> signal is created, the system may stop the generation of search queries.

In an embodiment, the encoder and decoder LSTM cells may use Gradient Descent Backpropagation to optimize the cross-entropy loss while determining the probability to predict the next token in the sequence. Further, one or more training data comprising aggregated user behavior data may be presented in a time series sequence and Information Search queries, which may be fed to the encoder and decoder LSTM cells.

In an embodiment, as an example, one or more training data comprising of aggregated user behavior data and Navigation Search queries may be fed to the encoder LSTM cell(s). The encoder LSTM cell(s) may use the attention mechanism on the encoded vector of the input sequence comprising behavior data and newly crawled popular data to predict one or more queries such as stock price of PCLN. The attention vector and weights for the LSTM cell(s) may be trained using Gradient Descent Backpropagation to minimize the cross entropy and predict search tokens.

In an embodiment, as an example, one or more input features may be entered into the LSTM cell(s). The input features may comprise one or more of word embeddings of search tokens, aggregated user behavior, user features such as location of the user or one or more demographic information of the user to rank the results. The output of the RNNs may be given as an input to the ranking module 1506.

In an embodiment, the behavior-to-search model of FIG. 16 may receive inputs using a time series data. Further, the inputs may include one or more word-tokens of the user's aggregated user behavior. These word tokens may be derived from one or more sources such as digital social platforms, previous search engine queries, offline location data, meeting information, user demographic information and vectors for the images seen by the user. Furthermore, the time associated with each of the events may be the time-series input source for the behavior-to-search model.

In an embodiment, consider the following example inputs for the behavior-to-search model.

Behavior Input in the last 5 hours: a) Social Feed—user saw a notification of Sam's upcoming 30th birthday, user liked Nicki's video on New Zealand, user commented on pictures of Jane's Lake Tahoe vacation pictures, among others. b) Advertisement feed—user read reviews in the advertisement of a book ‘Mathematics of Stock Market’ and user has clicked on an advertisement for ‘Unique Birthday gifts’. c) Offline Events—user went to an Artificial Intelligence meeting in San Francisco, user met his previous co-worker Christa at Starbucks in Palo Alto and user ate lunch at Olive Garden. d) Online shopping—user shops online for ‘home swing set’, user browses different brands of cheese, user chooses a home service for picking up laundry on a website. e) Online queries—user has used his VR gear to explore Grand Canyon and user searched for Bay Area home prices and PCLN stock <EOS>.

In an embodiment, the output may comprise the generated search tokens of the behavior-to-search model. As an example, the output may be: Actual Search queries in the next hour: AI Frontiers Conference, Birthday gifts for a 30-year-old, buy cheese online and vacations in New Zealand.

In an embodiment, in addition to the behavior vector, the titles/summary of newly crawled popular data from one or more search engines may be communicated as an input to the behavior-to-search model.

In an embodiment, the wide component of the figure comprises a linear model while the deep component may comprise a feed-forward neural network. The inputs may be in the form of strings, which are converted into a vector called embedding vector. One or more of these embeddings are initialized and trained to minimize a final loss function related to the training of the model. The deep component and the wide component may be combined using one or more weighted sums.

In an embodiment, one or more search queries may be entered as an input into a wide and deep neural network for the search queries trained to optimize logistic loss on predicting embeddings for search tokens. As an example, a network with memorization using Wide Neural Network may be used to predict one or more navigation search queries derived from cross training data. The training data may comprise one or more behavior patterns and search queries. The training data itself may be expressed as AND [pcln search query=1, peln search query] based on one or more past interactions of aggregated user behavior and the search queries. The deep neural network may use the embedding of the same aggregated user behavior and rank the informational search queries.

In an embodiment, a method for generating search tokens for a user may be provided. The method may comprise receiving and storing one or more user information in a user database. Further, the method may comprise identifying one or more profiles and accounts of the user on one or more digital platforms. The method may then comprise collecting and storing one or more information related to one or more activities of the user on the digital platforms and in external systems, in the user database. Subsequently, the method may comprise building a user profile vector to characterize the user's behavior and processing the user profile vector with the help of a learning module in order to derive one or more search tokens. Thereafter, the method may comprise ranking the search tokens to identify one or more content that may be of interest to the user.

In an embodiment, in case the user data related to the user's online profile and/or accounts was insufficient or unavailable, the server 1304 may build a user profile vector based on one or more other users who are similar to the user. This user profile vector or user profile behavior may be called an aggregated user profile. The aggregated user profile may be constructed by aggregating information from one or more websites and offline store actions. The websites may include one or more of social networks, search engines or websites. The activities of a similar user profile may be collected from multiple websites using one-way hashes to protect the privacy of the user. We may build a user profile vector to characterize the user's behavior. In an embodiment, this may be accomplished by summing up word vectors for search tokens aggregated from social feeds, search queries, chat history or information about friends. In another embodiment, the word vectors of tokens of anonymized behavioral data may be concatenated.

In an embodiment, while evaluating similarity between two or more users, their similarity may be computed using cosine similarity between two user vectors along with other variables such as conditional probability distances between the users. This step may also be combined with one or more bucketing techniques to increase the efficiency of the comparison.

In an embodiment, the user profiles may be hashed into one or more buckets using mechanisms such as Locality Sensitive Hashing algorithms to make the computation faster and reduce the memory space required for computing user similarity.

In an embodiment, the server 1304 may use one or more recommendation algorithms to predict search tokens and/or search queries based on aggregated user behavior.

In an embodiment, the server 1304 may be further configured to display the content to the user on one or more of the digital platforms used by the user.

In an embodiment, the digital platforms may include one or more of social networks, search engines, chat window, applications or websites.

In an embodiment, the content may include one or more of an advertisement, a notice, a suggestion or an actionable recommendation that capture the interest of the user.

In an embodiment, the system 1300 may determine when the merchant should send an actionable marketing message to the user. As an example, the system 1300 may determine whether the marketing message must be communicated to the customer before lunchtime or dinner time; or after a single day or after seven days of their previous purchase, among others. The timing of the marketing message may have a significant impact on its conversion rate. This problem may be treated as a regression problem in Machine Learning. One or more features such as previous transactions, search history and social media posts may be used to determine the timing of the marketing message for the user. Further, data related to responses from similar users computed using methods described above may also be used.

In an embodiment, another example of actionable content comprises the search query typed by the user into a search box. Search engines such as GOOGLE and MICROSOFT have been able to monetize the search traffic exceptionally well as the search query completely captures the user intent and has high actionable intent.

In an embodiment, a social network such as LINKEDIN may use the system 1300 to predict that one or more e-commerce executives may search for “conversational commerce software”. This may be accomplished by using one or more inputs such as the aggregated user behavior on the social network (in case the executive may be reading articles about conversational commerce), data from visits to the websites of conversational commerce companies, location information and offline meetings, among others.

In an embodiment, the predicted search tokens may be used by one or more search engines such as GOOGLE and MICROSOFT to pre-populate the search query in the search text box and show one or more search results.

In an embodiment, the method described above may be implemented by issuing a query for the predicted interests to a horizontal search engine such as GOOGLE.com and/or BING.com. The predicted interest intents may be derived by training a behavior-to-search neural network with one or more vectors gathered from the aggregated user behavior profile and one or more observed interest intent. Additionally, the deep reinforcement learning algorithm may be used to optimize the intent predictions further by observing the engagement with one or more predicted interests and aggregated user profiles.

In an embodiment, the generation of search tokens can be monetized. One or more applications showing one or more notifications to the user regarding new deals or upcoming meetings may become more efficient and accurate by using one or more aggregated behavior vectors gathered from multiple sources. As a first step, the aggregated behavior of the user may be used to ensure that the notification is a new notification. This may be done by implementing a semantic comparison between the new notification and any notifications that the user has seen in the past. In an embodiment, the semantic comparison may be done by computing the similarity between one or more paragraph vectors of the new event and one or more other events in the aggregated user behavior profile.

In an embodiment, once the system 1300 has confirmed that the notification is a new notification, the system 1300 may concatenate a personal preference (expressed, for example, as a category vector) and one or more demographic group vectors to the notification to ensure that it is a good notification to display to the user. The notification may be scored to evaluate its importance to the user. In an embodiment, this may be implemented by a simple cosine similarity between the user preference vector and the notification vector. The score may be used to show notifications in one more different colors depending upon the predicted engagement. An implicit engagement between the notification and the user aggregated profile may be further optimized by a deep reinforcement learning module to further improve the quality of the notification.

In an embodiment, one or more social networking sites may use the above-described method to personalize notifications displayed to users through their website. The personalization of notifications may be used to monetize one or more services offered or displayed by the social networking website.

### Monetization System for a Service Using Predicted Search Tokens

Once a user has determined their target customer base, the user may derive one or more keywords from the predicted search tokens. Further, using an application such as GOOGLE ADWORDS, the user may place a bid on shortlisted keywords.

In an embodiment, the user may use an application such as GOOGLE ADWORDS to reach new customers and grow their business. The user can become an active advertiser by targeting customers across the search network and the display network. The search network refers to Pay-Per-Click (PPC) advertising, wherein advertisers bid on keywords that may be relevant for their business to have a chance to display their advertisements to customers who enter those keywords into GOOGLE as part of their search query. The display network offers advertisers the option of placing visual banner advertisements on websites that are part of the Display network.

In an embodiment, advertising merchants may use an advertisement campaign management website on a social network and choose one or more predicted search keywords to show one or more advertisements on a social network and/or website.

In an embodiment, it is to be noted, that this is unlike existing advertising systems such as AdWords, wherein advertisers are bidding on search queries that happen on the search engine such as Google.com and Bing.com. As an example, a company selling a conversational commerce software such as VOICY.AI may bid on one or more advertising slots targeting ecommerce executives on social network such as LINKEDIN; wherein the executives are predicted to use a search engine to search for keywords such as “conversational software”, “conversational commerce companies”, “conversational commerce startups” in the next week or month.

In an embodiment, one or more inputs comprising previous purchase history vector, user profile vector, time intervals of aggregated actions, image vectors seen on social network, social feed, search history and AMAZON ALEXA queries, among other data aggregated from one or more search engines may be used to predict the search query of one or more commerce websites including FLIPKART.com, AMAZON.com and EBAY.com, using the system 1300 to generate one or more search tokens for the user.

In an embodiment, the aggregated user behavior profile may also be used to personalize the user's home page on one or more social networks and/or websites, based on the prediction of search/merchandising intent using the above methods. In an embodiment, personalization may be implemented by showing the user one or more items they may be interested in, using one or more predicted search queries.

In an embodiment, the predicted search tokens may be used to show one or more content to users on social networks and/or websites that the users may interact with. The predicted search tokens may also be used to show one or more relevant advertisements. Further, one or more advertisement slots on social networks and/or websites may be populated by auctioning them to one or more advertisers.

In an embodiment, the applications showing one or more notifications to the user regarding new deals or upcoming meetings may become more efficient and accurate by using one or more aggregated behavior vectors gathered from multiple sources. As a first step, the aggregated behavior of the user may be used to ensure that the notification is a new notification. This may be done by implementing a semantic comparison between the new notification and any notifications that the user has seen in the past. In an embodiment, the semantic comparison may be done by computing the similarity between one or more paragraph vectors of the new event and one or more other events in the aggregated user behavior profile.

In an embodiment, once the system 1300 has confirmed that the notification is a new notification, the system 1300 may concatenate a personal preference (expressed, for example, as a category vector) and one or more demographic group vectors to the notification to ensure that it is a good notification to display to the user. The notification may be scored to evaluate its importance to the user. In an embodiment, this may be implemented by a simple cosine similarity between the user preference vector and the notification vector. The score may be used to show notifications in one more different colors depending upon the predicted engagement. An implicit engagement between the notification and the user aggregated profile may be further optimized by a deep reinforcement learning module to further improve the quality of the notification.

### Generating Hyper-Personalized Marketing Messages

In an embodiment, one or more deep learning techniques may also be used to improve actionable advertisements that are specifically targeted at the user. Merchants today are spending on video and display advertising to increase their customer base. Such merchants may make better use of their marketing budget by targeting users with one or more hyper-personalized actionable ad (advertisements which require immediate action from the user) and by targeting users who may have an anticipated need soon.

In an embodiment, the hyper-personalized marketing message may be created by using deep reinforcement learning to compute the expected value of a content article for a given state of user interaction with a website/application/system. Depending on the context of the application, the state in reinforcement learning may be a combination of the user's search history and behavioral interest. The user's behavioral actions may include one or more clicks on a content article, filling a login form and completing a purchase action, among others.

In an embodiment, as an example for a hyper-personalized marketing message, the system 1300 may have collected and fed one or more inputs related to a user into the learning module. The inputs may comprise the user's social network media feed, browsing history and user impressions. Subsequently, the learning module 1512 may determine that the user may be interested in eating food from their favorite restaurant, “Olive Garden”, around noon. Further, the learning module may use past transactions of the user to determine their favorite dish and offer a discount of 20% on it. Consequently, the system 1300 may display one or more advertisements related to “Grilled Chicken Flatbread” around noon to the user through one or more devices 1302 of the user. In case the user does not click on the advertisement to pursue it, the system 1300 may determine that the user is not interested in the offer for that dish. Subsequently, the system 1300 may determine one or more other dishes that the user may be interested in. In case the user clicks on the advertisement, the system 1300 may communicate with the point of sale system of “Olive Garden” using an Application Programming Interface (API) call or through an email which may be communicated to the merchant. The user-id of the user may be encrypted when the marketing message is sent out to ensure the privacy of the user.

In an embodiment, an example of the advertisement communicated to the user may be “You have been a valuable customer of Olive Garden. We are happy to offer you 20% discount on your favorite dish “Grilled Chicken Flatbread” You can click “yes” to place an order.”. Subsequently, the user may click yes in the advertisement. Further, the user may order one or more dishes which will be communicated to the Point of Service system of the restaurant “Olive Garden”.

In an embodiment, the appropriate discount for the user may be determined using a Regression algorithm trained to optimize one or more variables including revenue per marketing message and/or conversion probability on the marketing message. As an example, in an embodiment, the system 1300 may determine an appropriate personalized discount for the user to complete a transaction with the merchant. As an example, a user may not be interested in a dish “Chicken Sandwich” at a 10% discount, but may be tempted to order the dish, in case a discount of 20% is offered to the customer.

In an embodiment, the predicted interests of the user may be used to display a personalized data feed on the user's device 2002, after the user unlocks the device 1302. This may decrease the time and effort put in by the user for typing and searching for one or more search queries.

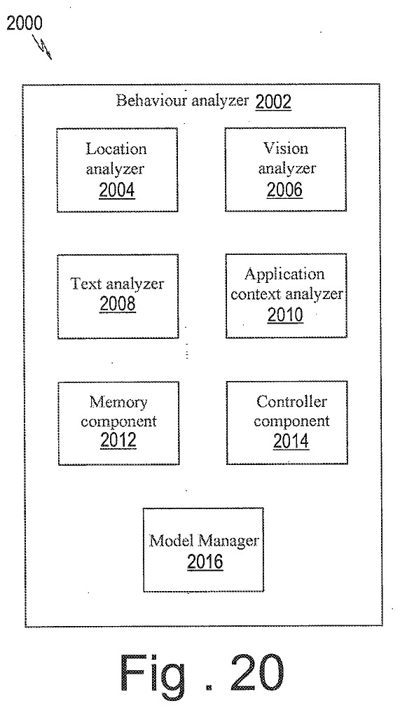

Referring to FIG. 20, a system 2000 is provided for generating content and recommending actions. The system 2000 is configured to generate content and recommend actions on a user device using a behaviour analyzer 2002.

The behaviour analyzer 2002 may be configured to learn the behaviour of a user of a device. The behaviour analyzer 2002 may learn the behaviour of the user by continuously studying the interactions of the user with the device. The behaviour analyzer 2002, may form a hypothesis on the activities of the user by continuously learning from the user interactions with different applications installed on the device and may generate content in a timely manner. The activities may include calling an individual, texting the individual after the phone call, capturing a photo, updating the photo on a social media, ordering food online and so on. The different applications installed on the device may be calling applications, messaging applications, call recorder, social media applications like FACEBOOK, INSTAGRAM, WHATSAPP and so on, online food ordering applications like SWIGGY, ZOMATO and so on. The device may be a mobile 2314. As an example, a user may use the device to capture a photo using a photo capturing application. If the user generally posts the photo using another application, such as a social networking application, after capturing the photo, then there is a high probability that the user will share the currently captured photo on the social networking application. The behaviour analyzer 2002 may have already learned about this behaviour of the user and would suggest the user to upload the photo on to the social networking application, after the photo is captured.

In an embodiment, to learn the user behaviour and predict the user actions, the behaviour analyzer 2002 may have a location analyzer 2004, a vision analyzer 2006, a text analyzer 2008, an application context analyzer 2010, a memory component 2012, a controller component 2014 and a model manager 2016.

The location analyzer 2004 may be configured to identify the location of the user/device and the characteristics of the location. As an example, the location analyzer 2004 may implement a triangulation method to determine the location of the user and may use available meta data around the location data to determine the characteristics of the location. The metadata may be an event entered by the user in the calendar application. The event may be a conference to be attended by the user on a specific date. As an example, the location analyzer 2004 may determine that the user is in a conference room, based on the identified location and the metadata information from the calendar.

The vision analyzer 2006 may be configured to analyse the images captured by the camera installed on the user device and the associated metadata. The metadata may be a birthday event, a picnic spot and so on. The vision analyzer 2006 may also analyse the device screen. The vision analyzer 2006 may break down the device screen into a series of pixels and then pass these series of pixels to a neural network. The neural network may be trained to recognize the visual elements within the frame of the device. By relying on a large database and noticing the emerging patterns, the vision analyzer 2006 may identify position of faces, objects and items, among others, in the frame of the device. The vision analyzer 106 may thus act as the “human eye” for the device.

The text analyzer 2008 may be configured to parse text in order to extract information. The text analyzer 2008 may first parse the textual content and then extract salient facts about type of events, entities, relationships and so on. As an example, text analyzer 2008 may identify the trend of messages the user may send to specific people.

The application context analyzer 2010 may be configured to analyse the past behaviour of the user. For the behaviour analyzer 2002 to predict the actions of the user, the past behaviour of the user should be studied. As an example, the user may call (using a first application) an individual. After the call ends, the user may send a text (using a second application) this individual. This series of behaviour (calling and then texting) may be repeated majority of the times the user makes phone calls to this specific person. The application context analyzer 2010 may analyse this series of past behaviour of the user. The output of the application context analyzer 2010 is to determine how the past behaviour of the user of the device will impact his future actions. The memory component 2012 may be configured to store the previous events/actions corresponding to the user. In context of the above example, the series of actions spread across multiple applications, of the user (calling and then texting) may be stored in the memory component 2012.

The controller component 2014 may be configured to coordinate with the location analyzer 2004, the vision analyzer 2006, the text analyzer 2008, the application context analyzer 2010 and the memory component 2012 to gather information of the behaviour of the user to predict the content and actions for the user.

The model manager 2016 may manage a personalized model 2208 a that is built for a specific user of the device. The model manager 2016 may also learn to manage the behaviour of a new user of a device. The behaviour analyzer 2002 may be personalized to predict the content and actions according to the individual's behaviour. The behaviour of one user may be different from that of another. As an example, a specific user may upload the photo captured (using first application) to a social media application (a second application) without editing (using a third application) the photo. Another user may upload the picture after editing them. The model manager 2016 may be trained to learn the particular behaviour of the user of the device to personalize the behaviour analyzer 2002. The model manager 2016 may learn from the feedback on the content and action recommendations of the user.

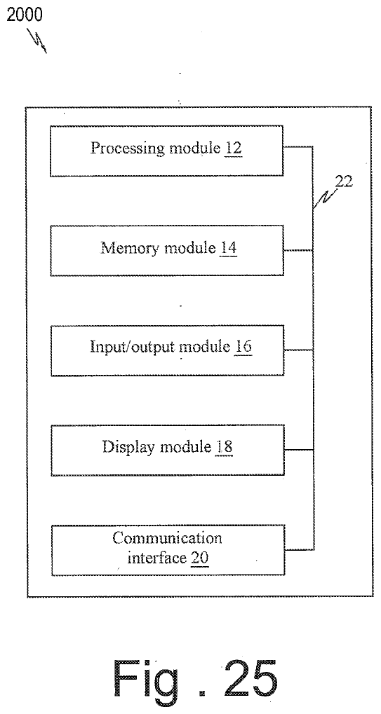

The behaviour analyzer 2002 may be implemented in the form of one or more processors and may be implemented as appropriate in hardware and software. Referring to FIG. 25, software implementations of the processing module 12 may include device-executable or machine-executable instructions written in any suitable programming language to perform the various functions described herein. The behaviour analyzer 2002 can run as offline process, whenever the user starts an application or as a process which executes every ‘x’ minutes or so. The number ‘x’ can be a configurable parameter.

A generalized model 2108 a may be trained based on a user cluster. The generalized model 2108 a may be introduced in the user device. The model manager 2016 of the behaviour analyzer 2002 may then personalize the generalized model 2108 a. As an example, as per a generalized model, the users of a specific cluster may capture a photo (using a first photo capturing application), edit the photo (using a second editing application) and uploading the edited photo to a first social networking application (using a third application). Whereas, a personalized model for a specific user could be, capture a photo (using the first photo capturing application), edit the photo (using the second editing application) and uploading the edited photo to a second social networking application (using a fourth application). In an embodiment, the model manager 2016 may initialize the generalized model 2108 a either during device setup or as part of the booting process.

Having discussed about the various modules involved in predicting the actions of the user and recommending content, the different implementations of the behaviour analyzer 2002 is discussed hereunder.

The behaviour analyzer 2002 may generate content and recommend actions for the user based on the past behaviour of the user. A generalized model 2108 a may be trained on the user cluster. The generalized model 2108 a may be trained for a group of users with similar profile. The generalized model 2108 a may then be personalized for a specific user of the device, which may be called as personalized model 2208 a. The behaviour analyzer 2002 may record actions of the user, to personalize the generalized model 2108 a. The actions may be performed across plurality of applications installed on the device. The personalized model 2208 a may recommend actions based on the recorded actions and may recommend a follow on action to be carried out on a second application. As an example, the follow on action may be uploading a photo on a social networking application (second application) after the photo is captured using a mobile camera application (first application).

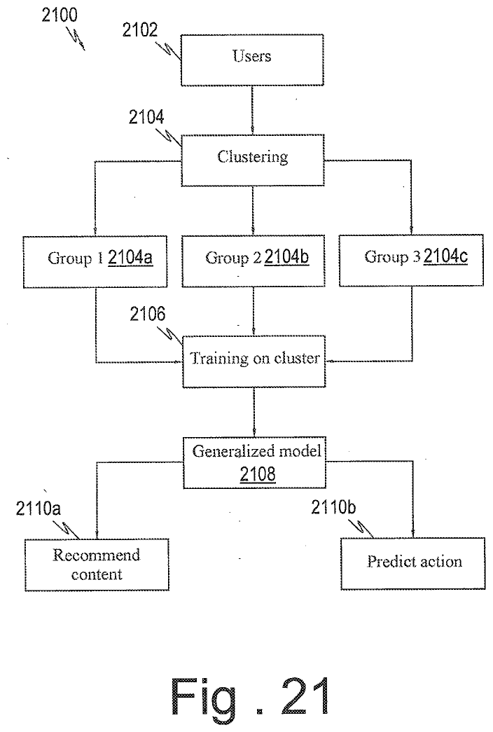

Referring to FIG. 21, at step 2104, the users may be clustered using a learning algorithm. The clustering of the users may result in generation of different user clusters, group 1 2104 a, group 2 2104 b and group 3 2104 c. The generalized model 2108 a may then be trained using a Neural network on the training data for the user clusters. Referring to step 2110 a and 2110 b, the trained generalized model 2108 a may recommend content and predict actions for the users of specific clusters using a prediction algorithm.

Having provided an overview of the steps involved in building the generalized model 2108 a, each of the steps is discussed in greater detail hereunder.

In an embodiment, referring to FIG. 21, at step 2104, the users can be clustered using the learning algorithm. The learning algorithm may be K-means clustering algorithm. K-means clustering groups an unlabelled data. An unlabelled data includes data without defined categories or groups. All of the users may form the unlabelled data. The K-means clustering algorithm find groups in the unlabelled user data, with the number of groups represented by the variable “K”. The algorithm works iteratively to assign each user (data point) to one of “K” groups based on the features of the user. The users may be clustered based on feature similarities. The features of the user may be age, behavioural characteristics, gender and so on. The output of K-means clustering algorithm may be clusters of users, group 1 2104 a, group 2 2104 b and group 3 2104 c, wherein each cluster may have similar features.

At step 2106, the user cluster may be trained using a deep Neural Network on large training data on the users of the cluster. The user cluster may be trained using the training data from the location analyzer 2004, the vision analyzer 2006, the text analyzer 2008, the application context analyzer 2010 and the memory component 2012 within the user cluster. As an example, the user cluster may be trained to upload a photo on FACEBOOK using training data. The location analyzer 2004 may have data about the location of the picture, the vision analyzer 2006 may have the image that has to be uploaded, the application context analyzer 2010 may have the data pertaining to the behaviour (uploading photo) of the cluster and this data may be stored in the memory component 2012.

At step 2108, the trained user cluster may form the generalized model 2108 a for specific user cluster. At step 2110 a and 2110 b, the generalized model 2108 a after learning the behavioural pattern of the cluster may recommend content and predict actions for the cluster based on the behavioural pattern of the cluster. In an embodiment, the generalized model 2108 a may predict a sequence of actions for the user cluster by using a Recurrent Neural Network (RNN). RNN algorithm is designed to work with sequence predictions. Sequence is a stream of data which are interdependent. RNN algorithm will have an input loop, an output loop and hidden layers between the input loop and the output loop. The output from a previous step will be taken as input for a current step. In this way RNN creates a network of input loops, process these sequence of inputs that are dependent on each other to predict the final output sequence. The generalized model 2108 a may continuously learn from the behavioural pattern of the cluster. As an example, the user may have a behavioural pattern of capturing a photo, editing the photo after capturing, uploading the photo on FACEBOOK and then sharing the same on INSTAGRAM. The RNN algorithm will process this sequence. The next time the user captures a photo and edit them, the generalized model 2108 a will recommend the user to upload the photo on FACEBOOK and then to share the same on INSTAGRAM. In an embodiment, the generalized model 2108 a may predict application actions for the user cluster by using a Deep Neural Network (DNN). The application actions may be sending a SMS (Short Message Service) to a friend, calling a merchant and so on.

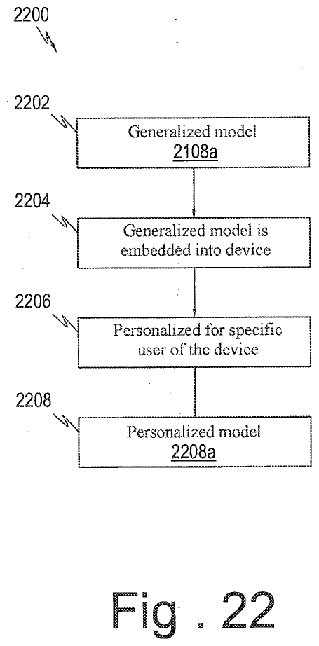

Referring to FIG. 22, at step 2204, the trained generalized model 2108 a of the behaviour analyzer 2002 may be embedded into the user device. The user may have carried out different actions across different application installed on the device before the generalized model is embedded on the device. When the generalized model 2108 a is embedded on the device, these sequence of actions may be learned by the generalized model 2108 a. The sequence of actions may be specific to a specific user of the device. The embedded generalized model 2108 a may thus be personalized for the specific user of the device, at step 2206. The personalization of the generalized model 208 a may generate a personalized model 2208 a (step 2208). The personalized model 2108 a may predict follow up actions based on the sequence of actions of the user.

In an embodiment, the personalization of the behaviour analyzer 2002 may be implemented using the learning algorithm. The learning algorithm may be Reinforcement Learning. Reinforcement Learning uses the concept of agent, actions, states and reward to attain a complex objective (content recommendation and action for the user of the device). As an example, the aggregated user behaviour, updates from the social media may be the state for the user. Content recommendation, displaying an application action may be the action of the algorithm. Correctly predicting the action at time “t” may be the reward function. In Reinforcement Learning, the agent (behaviour analyzer 2002) may be provided with the state. The agent may then take an action for the corresponding state. If the agent is successful in predicting the action at time “t”, then the agent will be rewarded with positive points (“+1”). If the agent is unsuccessful in predicting the action at time “t”, then the agent will be punished with negative points (“−1”). The agent will try to maximize the cumulative reward functions to achieve the best possible action. To figure out the action, the behaviour analyzer 2002 may implement policy learning algorithm. As an example, the behaviour analyzer 2002 may recommend uploading a picture using a social networking application after capturing the picture. In case the user accepts the recommended action, then the behaviour analyzer 2002 may be awarded a positive point. Else, the behaviour processor 2002 may be awarded a negative point. The behaviour analyzer 2002 may attempt to maximize the positive point to correctly predict the action of the user next time the user captures a photo. The personalized model 2108 a may maximize the positive points based on the acceptance (positive points) or rejection (negative points) of the actions recommended by the behaviour analyzer 2002. As an example, if the user accept to upload the photo after capturing the photo, the behaviour analyzer may be rewarded with a positive point. Whereas, if the user do not upload the photo after capturing the photo, the user may obtain a negative point. Based on these negative and positive points, the personalized model 2108 a may be refined. The In another embodiment, the behaviour analyzer 2002 may implement value iteration algorithm to figure out the action.

In another embodiment, an End to End Neural Network using an architecture consisting of Policy Gradient Deep Reinforcement Learning on top of a Deep Neural Network (DNN) may be applied. The DNN with attention can generate user behaviour embeddings on the offline user cluster behaviour data. The generic model then can be personalized for the user by adjusting the loss function in the Policy Gradient Deep Reinforcement Learning to predict the user actions.

In yet another embodiment, generalized model 2108 a may be trained to do imitation learning for user clusters on the behaviour sequence data. The user behaviour can be trained by implementing one shot learning algorithm.

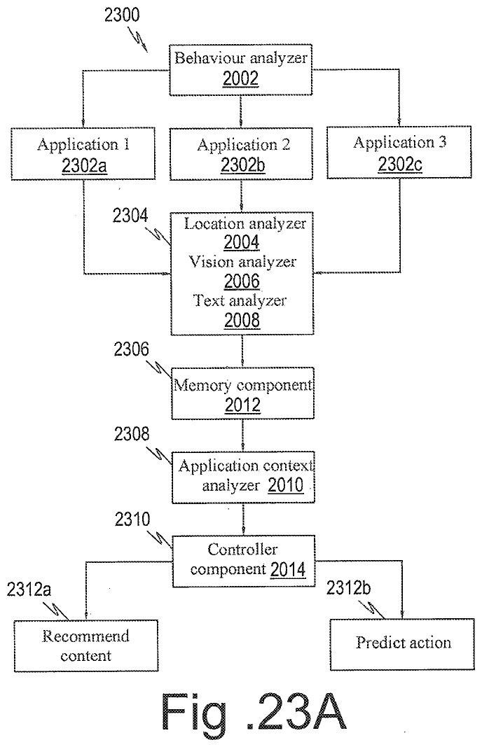

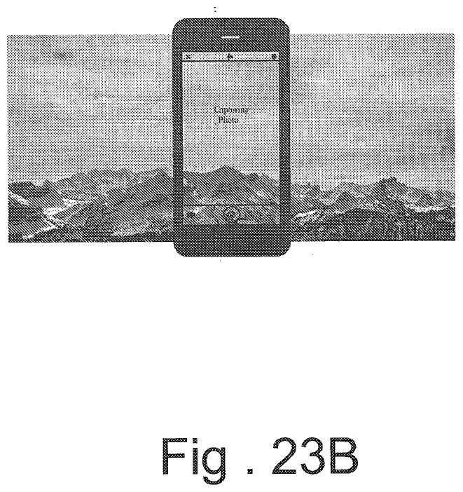

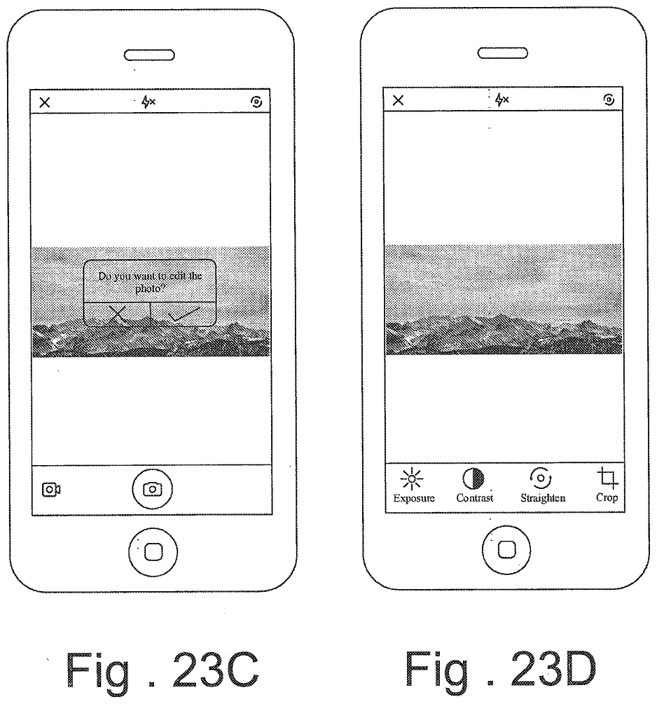

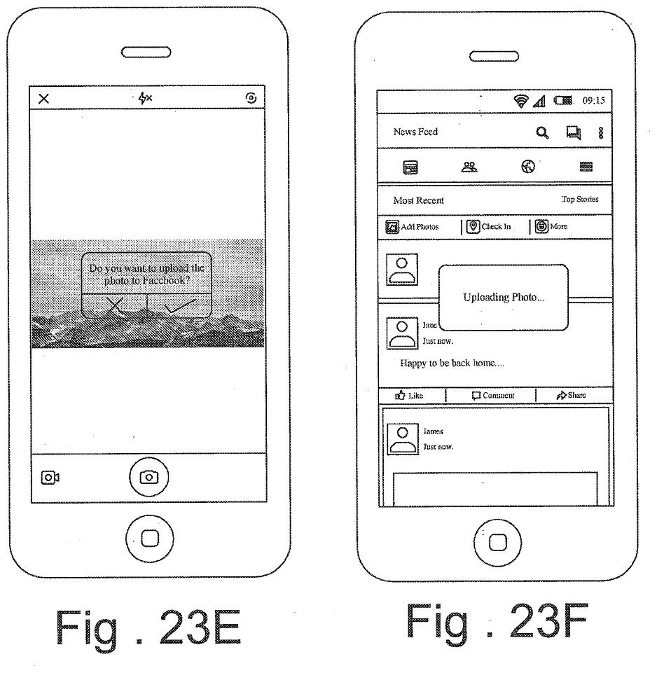

Referring to FIG. 23A, the behaviour analyzer 2002 may continuously learn from interactions of users with the different applications, application 1 2302 a, application 2 2302 b and application 3 2302 c, installed on the mobile 2314. As an example, the application 1 2302 a may be camera application, the application 2 2302 b may be a photo editor and the application 3 2302 c may be a social networking application. There may be more than 3 applications. At step 2304, the location analyzer 2004, the vision analyzer 2006 and the text analyzer 2008 may collect data and information from the different applications, application 1 2002 a, application 2 2002 b and application 3 2002 c. As an example, the data and information stored may include images captured by the camera application (application 1 2002 a), editing behaviour of the user in the photo editor (application 2 2002 b), uploading behaviour of the user on the social networking application (application 3 2002 c), different events stored in the calendar (application 23 (not shown)), and so on. At step 406, the data and information collected from the application 1 402 a, the application 2 2302 b and the application 3 2302 c may be stored in the memory component 2012. At step 2308, the data stored in the memory component 2012 may be analysed by the application context analyzer 2010. The application context analyzer 2010 may analyse the context of the actions in which the user had previously carried out the follow up actions after carrying out a first action. The context of the action may be based on the location of the device where the action is carried out and/or characterizing information associated with the location where the action is carried out and/or the time at which the action is carried out and/or the scheduled event at the time at which the action is carried out. As an example, the user may only upload the photos that are captured, at morning, on a picnic spot and may not upload photos captured at the user's office or any other time. At step 2310, the controller component 2014 gathers the data and the information to determine the behaviour of the user. At step 2312 a and 2312 b the controller component 2014 may recommend content and predict actions of the user if the context in which the first action is carried out correlates with the context in which the user had previously carried out the follow up action after carrying out the first action. As an example, the controller component 2014 may gather the image from the camera application, editing behaviour from the photo editor application, uploading behaviour of user, at different events, from social networking application and event marked in calendar to arrive at the conclusion that the user may upload photos, if the photos are captured at a picnic spot at morning time.

FIG. 23B, FIG. 23C, FIG. 23D and FIG. 23E illustrates an exemplary method of predicting user actions, by the behaviour analyzer 2002. Referring to FIG. 23B, the user of the mobile 2314 may open camera application (application 1 2302 a) to capture photo on New Year. As soon as the user completes capturing the photo, the behaviour analyser 2002 may send a pop-up 2316 “Do you want to edit the photo?” (FIG. 23C). If the user wishes to edit the photo, he may select “|”.

The behaviour analyzer 2002 may open the photo editor application (application 2 2302 b) for the user, wherein the user can edit the photo (FIG. 23D). Referring to FIG. 23E, on completion of photo edition, the behaviour analyzer may send another pop-up 2318 “Do you want to upload the photo on FACEBOOK?”. If the user wants to upload the photo on FACEBOOK, the user may select “═” on which the behaviour analyzer 2002 may upload the photo in the user's FACEBOOK (FIG. 23F). Referring to FIG. 23E, if the user do not wish to upload the photo in FACEBOOK, then he may select “x”, on which the behaviour analyzer 2002 may take the user back to the camera application. Referring to FIG. 23C, if the user do not want to edit the photo, then he may select “x”, upon which the behaviour analyzer 2002 may send a pop-up 2318 “Do you want to upload the photo on FACEBOOK?” (FIG. 23E). The user may select “□” if he wishes to upload the photo in FACEBOOK, on which the behaviour analyzer 2002 may upload the photo in the user's account in FACEBOOK (FIG. 23F). If the user do not wish to upload the photo in FACEBOOK, then he may select “x”, on which the behaviour analyzer 2002 may take the user back to his camera application.

In conventional methods, to benefit from an application, the user may have to first open the application and then browse through the menu option available in the application. To successfully operate the application, the user should have a basic knowledge about method of operation of the application. Further, on facing any issues in browsing the application, the user may have to call the customer care to resolve the issue. In an embodiment, the behaviour analyzer 2002 may act as a virtual agent for the user. The behaviour analyzer 2002 may use embodiments mentioned in patent application Ser. No. 15/356,512, which is herein in cooperated by reference, to understand the context of the application and act as the virtual agent. The behaviour analyzer 2002 may use the data from the location analyzer 2004, the vision analyzer 2006, the text analyzer 2008, the application context analyzer 2010, the memory component 2012, the controller component 2014 and the model manager 2016 to extract information on the application context and may learn the intentions of the user from the user's past behaviour. The application context may include information about text and images in the applications, the contents in the application which the user is interested in and so on. Based on these, the behaviour analyzer 2002 may answer questions about the services in the application. The behaviour analyzer 2002 may also do actions on the application, on behalf of the user. The behaviour analyzer 2002 may interact in natural language with the application. As an example, the user may be interested in ordering food online. The behaviour analyzer 2002 may filter food in accordance with the past behaviour of the user. The behaviour analyzer 2002 may also do other action such as placing the order, choosing the payment options, making payment and so on.

In an embodiment, the behaviour analyzer 2002 may use imitation learning algorithm to execute actions in the application. Imitation learning algorithm take behavioural pattern of the user as input and will replicate the behaviour of the user to execute actions on behalf of the user. In another embodiment, the behaviour analyzer may execute actions on behalf of the user by implementing one shot learning. One shot learning require minimum amount of data as input to learn the behaviour of the user.

The behaviour analyzer 2002 may act as a virtual agent for the ecommerce applications. The user of the ecommerce application, before purchasing a product may want to see how the product may look in a suitable environment. Such an experience is possible by Augmented reality. Augmented reality is an interactive experience of a real-world environment whereby elements of the virtual world is brought into the real world for enhancing the environment that the user experience. As an example, the user may purchase a sofa set from an ecommerce application such as AMAZON, FLIPKART and so on. In conventional approach, the user may have to choose the sofa set from the ecommerce application, open the camera application installed on user's mobile, point the camera at living room, drag the sofa set and then place the sofa set on the desired location to get a physical sense of how the sofa set fits in user's living room. The user may want to see how the product fits in his living room before finalizing on the product.

In an embodiment of the subject matter disclosed herein, the behaviour analyzer 2002 may place the sofa set in the user's living room, on his mobile screen, to give a physical sense of how the sofa set looks in his living room.

In an embodiment, the behaviour analyzer 2002 may act as a virtual agent, for executing the Augmented reality, for the ecommerce applications by first understanding the action and then completing the action. As an example, the action may be placing the sofa set on the user's living room.

In an embodiment, the behaviour analyzer 2002 with access of data from the location analyzer 2004, the text analyzer 2008, the application context analyzer 2010, the memory component 2012, the controller component 2014 and the model manager 2016 may act as a virtual agent for the ecommerce application. The virtual agent may take the voice input of the user, convert the voice to text to understand the action intended by the user. Other information elements required for understanding the action may be figured out using slot filing algorithm. In an embodiment, additional context that may be helpful for the virtual agent may be provided manually by the user. The additional context may include bitmap of the physical visual images captured by the camera of the device, textual description of the image and so on.

In an embodiment, the virtual agent may be trained to understand the virtual image in an ecommerce application (example: Sofa set), the title and the category of the image, the physical context and the natural language utterance by implementation of Neural module network.

After understanding the actions, the behaviour analyzer 2002 as an agent may need to complete the action. As an example, the behaviour analyzer 2002 may move the sofa set from one corner of the living room to the other corner. The action can be completed by the virtual agent, manually, by taking the input given by the user in natural language voice input. The user may give input to the virtual agent, which in turn may convert the natural language voice input to text input and then complete the action.

In an embodiment, the virtual agent may complete the actions by itself. The virtual agent may be trained by Deep Neural Network algorithm to automatically complete the actions. In an embodiment, Deep Reinforcement Learning approach on top of Neural Modules may be used for natural language understanding, object detection and scene understanding to execute actions.

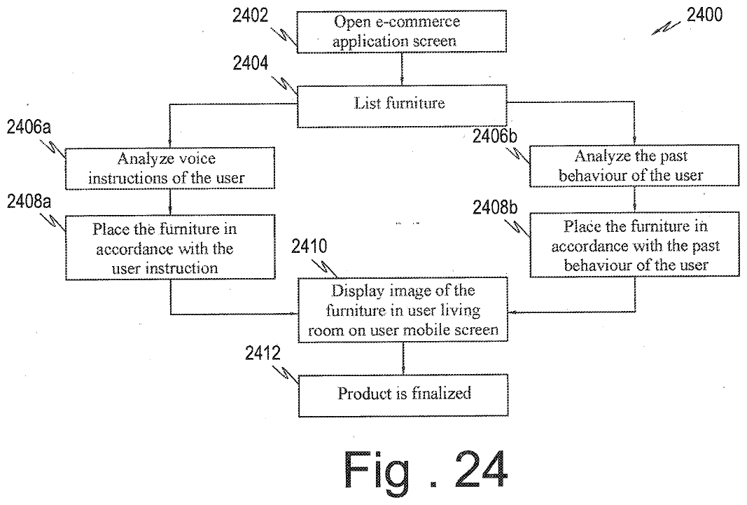

As an example, referring to FIG. 24, at step 2402, the user opens an e-commerce application. The user may browse through different products available on the application and at step 2404, the user may select a furniture for the user's living room. After the selection of the furniture, the user may provide voice instructions to the behaviour analyzer 2002 for placing the furniture in the living room (step 2406 a-step 2408 a). Alternatively, the behaviour analyzer 2002 may analyse the past behaviour of the user and suggest placing the furniture in the living room on behalf of the user (step 2406 b-2408 b).

In an embodiment, at step 2406 a, the user may give voice instructions to the behaviour analyzer 2002. The voice instructions of the user may be converted to text by the behaviour analyzer 2002 to understand the intent of the user. At step 2408 a, the behaviour analyzer 2002 may place the furniture in accordance with the instruction provided by the user, in the image of the living room as displayed in the mobile screen of the user. At step 2410, the user may get a visual experience of the furniture in the living room. If the user is satisfied with the product, the user may finalize on the product (2412) for purchase.

In an embodiment, at step 2406 b, the behaviour analyzer 2002 may analyse the past behaviour of the user to complete the action intended by the user. At step 2408 b, the behaviour analyzer 2002 may place the furniture in the living room, in accordance with the past behaviour of the customer. At step 2410, the user may get a visual experience of the furniture placed in the living room, on his mobile. If the user is satisfied with the product, at step 2412, the user may finalize the product for purchase.

In another embodiment, the virtual agent may execute actions by training the virtual agent by implementation of Imitation learning.

Having provided the description of the different implementations of the system 2000 for predicting the actions of the user and recommending contents based on user behavior, hardware elements of the system 2000 is discussed in detail hereunder.

FIG. 25 is a block diagram illustrating hardware elements of the system 2000 of FIG. 20, in accordance with an embodiment. The system 2000 may be implemented using one or more servers, which may be referred to as server. The system 2000 may include a 20 processing module 12, a memory module 14, an input/output module 16, a display module 18, a communication interface 20 and a bus 22 interconnecting all the modules of the system 2000.

The processing module 12 is implemented in the form of one or more processors and may be implemented as appropriate in hardware, computer executable instructions, firmware, or combinations thereof. Computer-executable instruction or firmware implementations of the processing module 12 may include computer-executable or machine-executable instructions written in any suitable programming language to perform the various functions described.

The memory module 14 may include a permanent memory such as hard disk drive, may be configured to store data, and executable program instructions that are implemented by the processing module 12. The memory module 14 may be implemented in the form of a primary and a secondary memory. The memory module 14 may store additional data and program instructions that are loadable and executable on the processing module 12, as well as data generated during the execution of these programs. Further, the memory module 14 may be a volatile memory, such as a random access memory and/or a disk drive, or a non-volatile memory. The memory module 14 may comprise of removable memory such as a Compact Flash card, Memory Stick, Smart Media, Multimedia Card, Secure Digital memory, or any other memory storage that exists currently or may exist in the future.

The input/output module 16 may provide an interface for input devices such as computing devices, keypad, touch screen, mouse, and stylus among other input devices; and output devices such as speakers, printer, and additional displays among others. The input/output module 16 may be used to receive data or send data through the communication interface 20.

The input/output module 16 can include Liquid Crystal Displays (OLCD) or any other type of display currently existing or which may exist in the future.

The communication interface 20 may include a modem, a network interface card (such as Ethernet card), a communication port, and a Personal Computer Memory Card International Association (PCMCIA) slot, among others. The communication interface 20 may include devices supporting both wired and wireless protocols. Data in the form of electronic, electromagnetic, optical, among other signals may be transferred via the communication interface 20.

In an implementation, ultra-wideband technology may be used to get centimetre resolution for recording positions of the items and position of the shopper, to increase the accuracy of the location systems. The three-dimensional model of aisles and items may then be used to guide the customer by using a route-finding algorithm.

Although embodiments have been described with reference to specific example embodiments; it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present disclosure will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the disclosure but as merely providing illustrations of some of the personally preferred embodiments of this disclosure. Thus, the scope of the disclosure should be determined by the appended claims and their legal equivalents rather than by the examples given.

What is claimed is:

1. A computer-implemented method for invoking an application programming interface based on a natural-language input, the method comprising:
maintaining, by a virtual agent server comprising at least one processor and a memory, a semantic registry of a plurality of application programming interfaces, the semantic registry comprising, for each application programming interface of the plurality, (i) an identifier of the application programming interface, (ii) a set of parameters of the application programming interface, and (iii) one or more synonym annotations associated with each parameter of said set;
receiving, by the virtual agent server, a natural-language input from a user;
determining, by the virtual agent server, a desired action of the user and a context corresponding to the desired action from the natural-language input;
selecting, by the virtual agent server from the semantic registry, one of the plurality of application programming interfaces by matching one or more tokens of the natural-language input against the synonym annotations of the semantic registry;
deriving, by the virtual agent server, a set of parameter values for the selected application programming interface from the desired action and the context, wherein the deriving comprises (i) retrieving a plurality of past dialogs from a dialog history associated with the user, (ii) annotating one or more tokens of the past dialogs with labels using an entity name recognition technique, and (iii) executing one or more inference rules on the annotated past dialogs to derive at least one of the parameter values; and
performing at least one of: (i) transmitting, by the virtual agent server, an invocation request configured to cause a client application to invoke the selected application programming interface using the derived set of parameter values, and (ii) invoking, by the virtual agent server, the selected application programming interface with the derived set of parameter values.

2. The method of claim 1, wherein the synonym annotations are organized as an inverted index, and wherein said selecting comprises performing a first-pass lookup against the inverted index using the one or more tokens of the natural-language input followed by a second-pass ranking using a learn-to-rank algorithm.

3. The method of claim 2, wherein the learn-to-rank algorithm comprises a Gradient Boosted Decision Tree.

4. The method of claim 1, wherein the deriving the set of parameter values further comprises selecting one of (i) a question-and-answering process that constructs a question for each parameter and processes the question against the dialog history, (ii) a slot-filling process, and (iii) a process that applies manually-configured rules with regular expressions and grammars to parse parameter values from textual patterns.

5. The method of claim 1, wherein the natural-language input comprises at least one of an audio speech, a transcribed text, and a textual chat input.

6. The method of claim 1, further comprising determining, prior to said invoking, whether the user is authorized to invoke the selected application programming interface with the derived set of parameter values, and conditioning the invoking on a positive determination of authorization.

7. The method of claim 6, wherein the determining whether the user is authorized comprises comparing a voice biometric of the user with an existing voice biometric, validating a phone number associated with the user, and computing a signature of the user's conversation style based on frequently occurring words in communication with the virtual agent server.

8. The method of claim 6, wherein the determining whether the user is authorized comprises evaluating the derived set of parameter values against a permission scope associated with the user, the permission scope being derived at least in part from action records of the user aggregated from a plurality of applications, the action records being aggregated using a distributed processing framework.

9. The method of claim 1, wherein the invoking the selected application programming interface comprises transmitting, by the virtual agent server, a request to a second virtual agent server associated with an external system, the request comprising the desired action, the context, and the derived set of parameter values, the request being transmitted as one of (i) an application programming interface call and (ii) a natural-language dialog exchange, and wherein the second virtual agent server executes the selected application programming interface on behalf of the user.

10. The method of claim 9, further comprising exchanging, between the virtual agent server and the second virtual agent server, one or more optimization options corresponding to the desired action; identifying a common optimization option present in both an optimization option set associated with the user and an optimization option set associated with the external system; and executing the selected application programming interface in accordance with the common optimization option.

11. The method of claim 1, wherein the deriving the set of parameter values further comprises retrieving runtime context information from at least one of a calendar application and a location service, and incorporating the retrieved runtime context information into at least one of the parameter values.

12. The method of claim 1, further comprising executing on a client device a previously-pushed software code and data set to produce the derived set of parameter values when a network connectivity to the virtual agent server is unavailable, wherein the data set is structured as a hashmap.

13. The method of claim 1, wherein the desired action and the context are determined using term-frequency-inverse-document-frequency weighting of tokens of the natural-language input, weighted by recency of the user's communication session.

14. The method of claim 1, wherein the deriving the set of parameter values further comprises mapping a state identified by a dialog module to a user command using an offline-constructed mapping built using pattern matching and entity name recognition techniques.

15. The method of claim 1, wherein the semantic registry is populated at least in part by automatic discovery of one or more application programming interfaces through at least one of a schema-based parsing and a web service discovery.

16. The method of claim 1, wherein the invocation request comprises a JSON-formatted payload identifying the application programming interface, parameter values, and execution instructions.

17. A virtual agent system, comprising:
at least one processor;
a memory communicatively coupled to the at least one processor and storing a semantic registry of a plurality of application programming interfaces, the semantic registry comprising, for each application programming interface of the plurality, (i) an identifier of the application programming interface, (ii) a set of parameters of the application programming interface, and (iii) one or more synonym annotations associated with each parameter of said set;
wherein the memory further stores instructions that, when executed by the at least one processor, cause the at least one processor to:
receive a natural-language input from a user,
determine a desired action of the user and a context corresponding to the desired action from the natural-language input,
select, from the semantic registry, one of the plurality of application programming interfaces by matching one or more tokens of the natural-language input against the synonym annotations,
derive a set of parameter values for the selected one of the application programming interfaces from the desired action and the context, by (i) retrieving a plurality of past dialogs from a dialog history associated with the user, (ii) annotating one or more tokens of the past dialogs with labels using an entity name recognition technique, and (iii) executing one or more inference rules on the annotated past dialogs to derive at least one of the parameter values, and
perform at least one of: (i) transmitting an invocation request configured to cause a client application to invoke the selected application programming interface using the derived set of parameter values, and (ii) invoking the selected one of the application programming interfaces with the derived set of parameter values.

18. The virtual agent system of claim 17, wherein the synonym annotations are organized as an inverted index, and wherein the instructions cause the at least one processor to perform a first-pass inverted-index lookup followed by a second-pass learn-to-rank scoring.

19. The virtual agent system of claim 17, wherein the instructions further cause the at least one processor to determine, prior to said invoking, whether the user is authorized to invoke the selected one of the application programming interfaces with the derived set of parameter values.

20. The virtual agent system of 19, wherein the determination of the authorization comprises evaluating the derived set of parameter values against a permission scope associated with the user, the permission scope being derived at least in part from action records of the user aggregated from a plurality of applications via a distributed processing framework.

21. The virtual agent system of claim 17, wherein the system comprises a virtual agent client component and a virtual agent server component, the virtual agent client component being executable on a user device and being configured to execute, when communication with the virtual agent server component is unavailable, a previously-pushed software code and a hashmap-structured data set to produce the derived set of parameter values.

22. A non-transitory computer-readable medium storing instructions that, when executed by at least one processor, cause the at least one processor to perform operations comprising:
maintaining a semantic registry of a plurality of application programming interfaces, the semantic registry comprising, for each application programming interface, an identifier, a set of parameters, and one or more synonym annotations associated with each parameter;
receiving a natural-language input from a user;
determining a desired action of the user and a context corresponding to the desired action from the natural-language input;
selecting one of the plurality of application programming interfaces by matching one or more tokens of the natural-language input against the synonym annotations;
deriving a set of parameter values for the selected one of the application programming interfaces by retrieving a plurality of past dialogs from a dialog history of the user, annotating tokens of the past dialogs with labels using an entity name recognition technique, and executing one or more inference rules on the annotated past dialogs; and
performing at least one of: (i) transmitting an invocation request configured to cause a client application to invoke the selected application programming interface using the derived set of parameter values, and (ii) invoking the selected application programming interface with the derived set of parameter values.
